(19) United States
(12) Patent Application Publication
(10) Pub. No.: US 2018/0224270 A1
(43) Pub. Date: Aug. 9, 2018

(54) THREE-DIMENSIONAL IMAGER HAVING CIRCULAR POLARIZERS

(71) Applicant: FARO Technologies, Inc., Lake Mary, FL (US)

(72) Inventors: Matthias Wolke, Korntal-Munchingen (DE); Rolf Heidemann, Stuttgart (DE); Matthew Amstrong, Glenmoore, PA (US)

(21) Appl. No.: 15/879,988

(22) Filed: Jan. 25, 2018

Related U.S. Application Data
(60) Provisional application No. 62/455,839, filed on Feb. 7, 2017.

(51) Int. Cl. G01B 11/25; G06T 7/73; G02B 27/28; G01S 17/48; G01S 7/486

(52) U.S. Cl. CPC G01B 11/2545; G06T 7/73; G01S 7/4865; G01S 17/48; G02B 27/28

(57) ABSTRACT

A three-dimensional (3D) measuring system includes a triangulation scanner having a projector and a first triangulation camera, the projector including a first circular polarizer, the first triangulation camera including a second circular polarizer, the second circular polarizer having handedness opposite the first circular polarizer.

### CROSS REFERENCE TO RELATED APPLICATIONS

This application claims the benefit of U.S. Provisional Application Ser. No. 62/455,839 filed Feb. 7, 2017, the entire disclosure of which is incorporated herein by reference.

### FIELD OF THE INVENTION

The subject matter disclosed herein relates in general to a three-dimensional (3D) measuring device that use reflected light to measure 3D coordinates of objects.

### BACKGROUND

One type of 3D measuring device is a triangulation scanner that uses a triangulation method to measure the 3D coordinates of points on an object. The triangulation scanner usually includes a projector that projects onto a surface of the object either a pattern of light in a line or a pattern of light covering an area. A camera is coupled to the projector in a fixed relationship, for example, by attaching a camera and the projector to a common frame. The light emitted from the projector is reflected off of the object surface and detected by the camera. Since the camera and projector are arranged in a fixed relationship, the distance to the object may be determined using trigonometric principles. Compared to coordinate measurement devices that use tactile probes, triangulation systems provide advantages in quickly acquiring coordinate data over a large area. As used herein, the resulting collection of 3D coordinate values or data points of the object being measured by the triangulation system is referred to as point cloud data or simply a point cloud. A particular type of triangulation measurement is a six degree-of-freedom (six-DOF) measurement device having a position and orientation measured by a six-DOF laser tracker.

Another type of 3D measuring device is a time-of-flight (TOF) scanner that sends a beam of light to an object and determines the distance to the object based at least in part on the round-trip time to the object. Such TOF scanners further include angle-measuring devices to measure two angles of the beam of light.

A problem commonly encountered by triangulation scanners is multipath interference, which may result in erroneous values being determined 3D coordinates. There is a need for methods that recognize and minimize 3D scanning errors from multipath interference. Another problem encountered by both triangulation scanners and TOF scanners is inability to measure objects because of a small amount of returned light, for example, because an object is nearly transparent or highly polished. Another problem encountered by handheld triangulation scanners is lack of adequate detail and sufficient accuracy in measured objects. Another problem encountered by triangulation scanners and TOF scanners is inability to see subtle features such as dents, scratches, chemical saturation, and surface texture. There is a need for common methods that improve performance in these areas.

Accordingly, while existing 3D triangulation scanners and 3D TOF scanners are suitable for their intended purpose, the need for improvement remains.

### BRIEF DESCRIPTION

According to an embodiment of the present invention, a three-dimensional (3D) measuring system comprises: a triangulation scanner having a projector and a first triangulation camera, the projector including a first circular polarizer, the first triangulation camera including a second circular polarizer, the second circular polarizer having handedness opposite the first circular polarizer.

According to a further embodiment of the present invention, a method for measuring three-dimensional (3D) coordinates of an object, comprises: providing a triangulation scanner including a projector, a first triangulation camera, and a processor, the projector including a first circular polarizer, the first triangulation camera including a second circular polarizer having a handedness opposite the first circular polarizer; projecting with the projector a first pattern of light onto an object; capturing with the first triangulation camera a first image of the first pattern of light on the object; determining with the processor 3D coordinates of points on the object based at least in part on the projected first pattern and on the captured first image; and storing the 3D coordinates of the 3D coordinates of the points on the object.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 is a perspective view of a triangulation scanner according to an embodiment of the present invention;

FIG. 2 is a block diagram of electrical components of a triangulation scanner according to an embodiment of the present invention;

FIG. 3 is a schematic illustration of the principle of operation of a triangulation scanner having a camera and a projector according to an embodiment of the present invention;

FIG. 4 is a schematic illustration of the principle of operation of a triangulation scanner having a projector and two cameras according to an embodiment of the present invention;

FIG. 5 is an isometric illustration of a triangulation scanner having a projector and two triangulation cameras arranged in a triangular pattern and further including a registration camera according to an embodiment of the present invention;

FIG. 6A and FIG. 6B are perspective and front views of a handheld triangulation scanner according to an embodiment of the present invention;

FIG. 7A is an isometric view of a detached laser line probe (LLP) according to an embodiment of the present invention;

FIG. 7B is an isometric view of an LLP coupled to an articulated arm coordinate measuring machine (AACMM) according to an embodiment of the present invention;

FIG. 7C is a front view of an LLP coupled to a stereo camera overview device according to an embodiment of the present invention;

FIG. 8A is an isometric view of a laser tracker according to an embodiment of the present invention;

FIG. 8B is a schematic side view of a six-DOF laser tracker and six-DOF triangulation scanner according to an embodiment of the present invention;

FIG. 9A and FIG. 9B are isometric and side views, respectively, of a TOF scanner according to an embodiment of the present invention;

FIG. 9C is a schematic view showing internal elements of the TOF scanner according to an embodiment of the present invention;

FIG. 10 is a schematic representation of a triangulation system showing the origin of multipath interference;

FIG. 11A and FIG. 11B are schematic representations of a projector and a camera each having a circular polarizer, illustrating the resulting effects on a primary reflection according to an embodiment according to an embodiment of the present invention;

FIG. 12A and FIG. 12B are schematic representations of a projector and a circular polarizer, illustrating the resulting effects on a secondary reflection according to an embodiment according to an embodiment of the present invention;

FIG. 13 is a plot diagram of the angle of incidence versus transmittance through a circular polarizer, illustrating the transmittance of a light reflecting off aluminum and passing through a circular polarizers having same- and opposite-handedness according to embodiments of the present invention;

FIG. 14A is a computer generated image generated from a camera that shows the primary and secondary reflections from a bracket;

FIG. 14B is a computer generated image acquired from a camera that shows the secondary reflections blocked by placing a circular polarizer on the projector and a circular polarizer of the opposite handedness on the camera according to an embodiment of the present invention;

FIG. 15A and FIG. 15B are computer generated images acquired from a camera that show a bracket illuminated by light from a projector having a projector with a circular polarizer with FIG. 15A that shows primary reflections passed through a circular polarizer of the opposite handedness and with FIG. 15B showing secondary reflections passed through a circular polarizer of the same handedness according to an embodiment of the present invention;

FIG. 16A is an isometric view of a triangulation scanner having a circular polarizer on a projector, a circular polarizer of opposite handedness on the triangulation cameras, and a circular polarizer of same handedness on a reference camera according to an embodiment of the present invention;

FIG. 16B and FIG. 16C are front and side views of a polarizer unit, a lens, and a photosensitive array with electronics, the polarizer unit including a mechanism permitting selection of a circular polarizer and plain glass according to an embodiment of the present invention;

FIG. 16D and FIG. 16E are front and side views of a polarizer unit, a lens, and a photosensitive array with electronics, the polarizer unit including a mechanism permitting selection of a circular polarizer and plain glass according to an embodiment of the present invention;

FIG. 17 is a schematic representation of a six-DOF tracker and a six-DOF triangulation scanner including circular polarizers to reduce or minimize the effects of multipath interference according to an embodiment of the present invention;

FIG. 18 is an isometric view of a line scanner having adjustable polarization states according to an embodiment of the present invention;

FIGS. 19A, 19B, and FIG. 19C illustrate specular reflection, scattered reflection, and depolarized diffuse reflection, respectively;

FIGS. 20A, 20B, 20C, and FIG. 20D show four linear polarizers placed in front of a camera according to an embodiment of the present invention;

FIGS. 21A, 21B, 21C, 21D show computer generated images acquired by a camera that illustrated the results from the linear polarization states created by the linear polarizers of FIGS. 20A, 20B, 20C, 20D, respectively;

FIGS. 22A, 22B, and FIG. 22C show computer generated images acquired by a camera of an intensity image, degree-of-polarization (DOP) image, and an angle-of-polarization (AOP) image, respectively, obtained from the four images of FIGS. 21A, 21B, 21C, and FIG. 21D according to an embodiment of the present invention;

FIG. 23 is an isometric illustration of a TOF scanner having a polarization unit according to an embodiment of the present invention;

FIGS. 24A, 24B, and FIG. 24C are isometric, front schematic, and side schematic views, respectively, of a polarization unit according to an embodiment of the present invention;

FIGS. 25A, 25B, and FIG. 25C are a front schematic representation of a first type of polarization mechanism, a front schematic representation of a second type of polarization mechanism, and a side schematic representation of a polarization unit, respectively, according to embodiments of the present invention;

FIG. 26A and FIG. 26B are front schematic and side schematic representations, respectively, of a polarization unit according to an embodiment of the present invention;

FIGS. 27A, 27B, and FIG. 27C are a front schematic representation of a first type of polarization mechanism, a front schematic representation of a second type of polarization mechanism, and a side schematic representation of a polarization unit, respectively, according to embodiments of the present invention;

FIGS. 28A, 28B, 28C, and FIG. 28D are four polarization states of a polarization unit according to an embodiment of the present invention;

FIG. 28E is a side schematic view of a polarization unit according to an embodiment of the present invention;

FIG. 29 is an exploded isometric view of a polarization unit according to an embodiment of the present invention;

FIG. 30A is a schematic view of a polarization unit according to an embodiment of the present invention;

FIGS. 30B and 30C are pixels and corresponding polarization elements of the polarization unit of FIG. 30A according to an embodiment of the present invention;

FIG. 31A and FIG. 31B are front views of triangulation cameras having polarization units according to embodiments of the present invention;

FIG. 32 is a front view of a line scanner and stereo camera having polarization elements and used in a handheld mode according to an embodiment of the present invention;

FIG. 33 is a side schematic view of a six-DOF laser tracker and a six-DOF triangulation scanner with a polarization unit having a rotational selection mechanism according to an embodiment of the present invention;

FIGS. 34A, 34B, 34C are images of a translucent sphere, a first feature on the sphere surface observed from a calculated DOP, and a second feature of the sphere surface observed from a calculated DOP, respectively, according to embodiments of the present invention;

FIG. 35A is a computer-generated 3D image obtained with a TOF scanner with 3D information missing for the scanned transparent windows according to an embodiment of the present invention;

FIG. 35B is a computer-generated DOP image of transparent windows obtained with a polarization unit according to an embodiment of the present invention;

FIG. 36 is a computer-generated image showing cardinal points extracted using a scale-invariant feature transform (SIFT) algorithm according to an embodiment of the present invention;

FIG. 37A and FIG. 37B show cardinal points extracted using natural features according to embodiments of the present invention;

FIG. 38A is a computer-generated display that includes a box that encloses a dynamic 2D image with previously captured 3D scan data outside the box according to an embodiment of the present invention;

FIG. 38B is a computer-generated image of a close-up of the box that encloses the dynamic 2D image of FIG. 38A, with cardinal points marked to permit registration of multiple data sets according to an embodiment of the present invention;

FIG. 39A is a computer-generated intensity image obtained with a TOF scanner according to an embodiment of the present invention;

FIG. 39B is a computer-generated DOP image obtained with a polarization unit having at least three linear polarizers at different angles according to an embodiment of the present invention;

FIG. 39C is a graphical representation of a wall, a window and a support structure between the wall and window, with corner points and edge points marked according to an embodiment of the present invention;

FIG. 39D is a graphical representation of a window showing normal vectors to the window surface according to an embodiment of the present invention;

FIG. 40 is an isometric view of a triangulation scanner that further includes a polarization unit for capturing three or more images with linear polarizers at different angles according to an embodiment of the present invention;

FIG. 41A and FIG. 41B are a computer-generated intensity image and a DOP image, respectively, according to an embodiment of the present invention;

FIG. 41C and FIG. 41D are a computer-generated intensity image and a DOP image, respectively, according to an embodiment of the present invention;

FIGS. 42A, 42B, and FIG. 42C depict steps taken to identify the regions that receive multipath interference according to an embodiment of the present invention;

FIGS. 42D, 42E, and FIG. 42F depict steps take to illuminate identified regions with structured light in a manner that reduces or avoids multipath interference according to an embodiment of the present invention;

FIGS. 42G, 42H, 42J, and FIG. 42K depict a method for identifying an orientation of an object that reduces or minimizes multipath interference when illuminated by a triangulation scanner according to an embodiment of the present invention;

FIG. 43A and FIG. 43B are a computer-generated intensity image and a DOP image, respectively, with the DOP image revealing the presence of a chemical spot according to an embodiment of the present invention;

FIG. 44A and FIG. 44B are a computer-generated intensity image and a DOP image, respectively, with the DOP image revealing a textural pattern on the imaged objects according to an embodiment of the present invention;

FIG. 45 is a computer-generated image illuminated by linearly polarized light showing a pattern in the imaged object according to an embodiment of the present invention;

FIG. 46A and FIG. 46B are a computer-generated intensity image and a DOP image, respectively, with the DOP image revealing a dent in the object according to an embodiment of the present invention; and

FIG. 47A and FIG. 47B are an intensity image and a DOP image, respectively, of an object, with the DOP image more clearly showing a scratch in the imaged object according to an embodiment of the present invention.

The detailed description explains embodiments of the invention, together with advantages and features, by way of example with reference to the drawings.

### DETAILED DESCRIPTION

Embodiments of the present invention provide advantages in recognizing and reducing or minimizing 3D errors from multipath interference. Embodiments further provides advantages in providing an ability to measure objects that return a relatively small amount of projected light, for example, because the object is nearly transparent or highly reflective. Embodiments further provide advantages in providing improved detail and accuracy in measured objects. Embodiments further provide advantages in more clearly displaying subtle features such as dents, scratches, chemical presence, and surface texture.

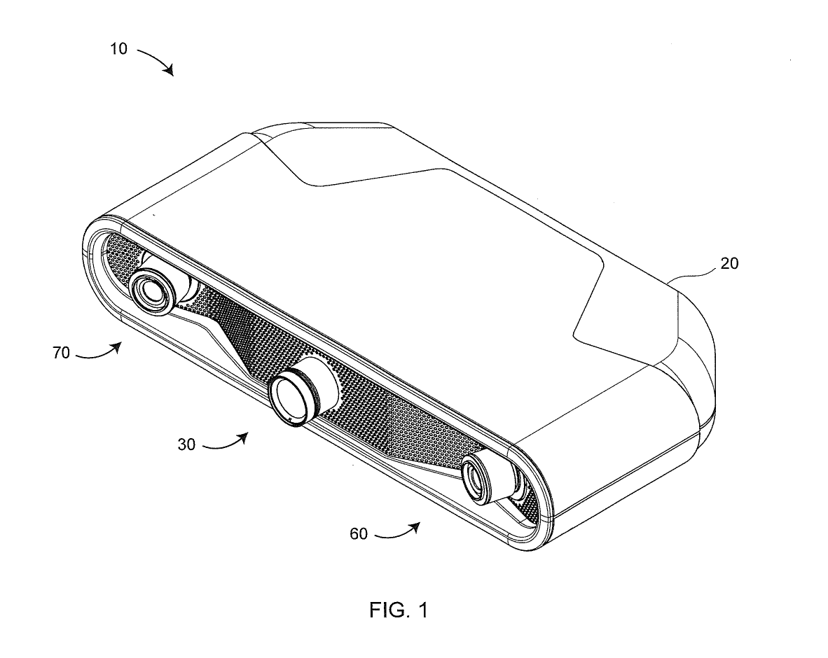

FIG. 1 is a perspective view of a triangulation scanner 10, also referred to as a 3D imager 10, according to an embodiment. It includes a frame 20, a projector 30, a first camera assembly 60, and a second camera assembly 70. In another embodiment, the 3D imager 10 includes only one camera rather than two cameras.

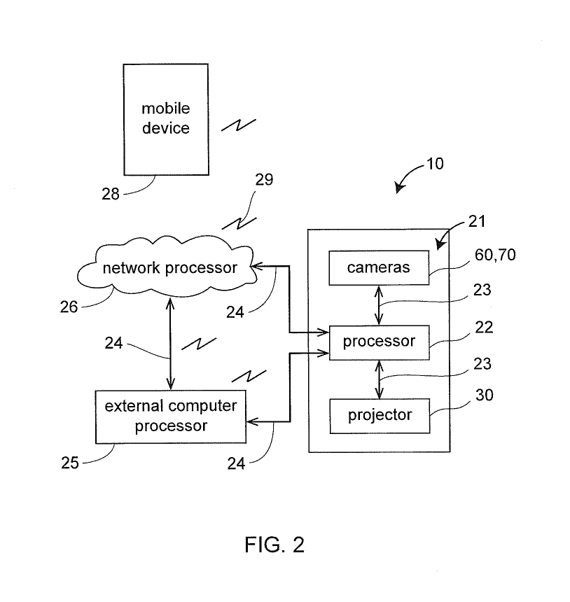

In an embodiment illustrated in FIG. 2, the 3D imager 10 includes an internal electrical system 21 that includes a processor 22 that communicates with electrical components. In an embodiment, the processor 22 communicates with electrical components of projector 30 and cameras 60, 70 by electrical lines 23. The processor 22 may include a plurality of processor elements such as microprocessors, digital signal processors (DSPs), field-programmable gate arrays (FPGAs), memory components, or any other type of device capable of performing computing or storage functions. The processor 22 may communicate with an external computer processor 25 or a network processor 26 over a communications medium such as wired channels 24 or wireless channels 29. The external computer processor 25 may bidirectionally communicate with the network processor 26 over wired channels 24 or wireless channels 29. In an embodiment, one or more of the processor 22, the external computer 25, and the network processor 26 communicate over a wireless channel 29 with a mobile device 28 such as a smart mobile phone or a computer tablet.

Communication among the computing (processing and memory) components may be wired or wireless. Examples of wireless communication methods include IEEE 802.11 (Wi-Fi), IEEE 802.15.1 (Bluetooth), and cellular communication (e.g., 3G, 4G, and 5G). Many other types of wireless communication are possible. A popular type of wired communication is IEEE 802.3 (Ethernet). In some cases, multiple external processors, such as network processors 26 may be connected in a distributed computing configuration, such as cloud based computing. These network processors 26 may be used to process scanned data in parallel, thereby providing faster results, especially where relatively time-consuming registration and filtering may be required.

In an embodiment, the projector 30 includes a light source such as a light emitting diode (LED) that projects light onto a digital micromirror device (DMD). In an embodiment, the processor 22 sends the projector 30 relatively high speed electrical pattern sequences that result in the projection of the indicated patterns of light. In other embodiments, other types of image-generating devices are used in the projector. Examples include transparency slides, liquid crystal on silicon (LCoS) arrays, and holographic optical elements (HOEs).

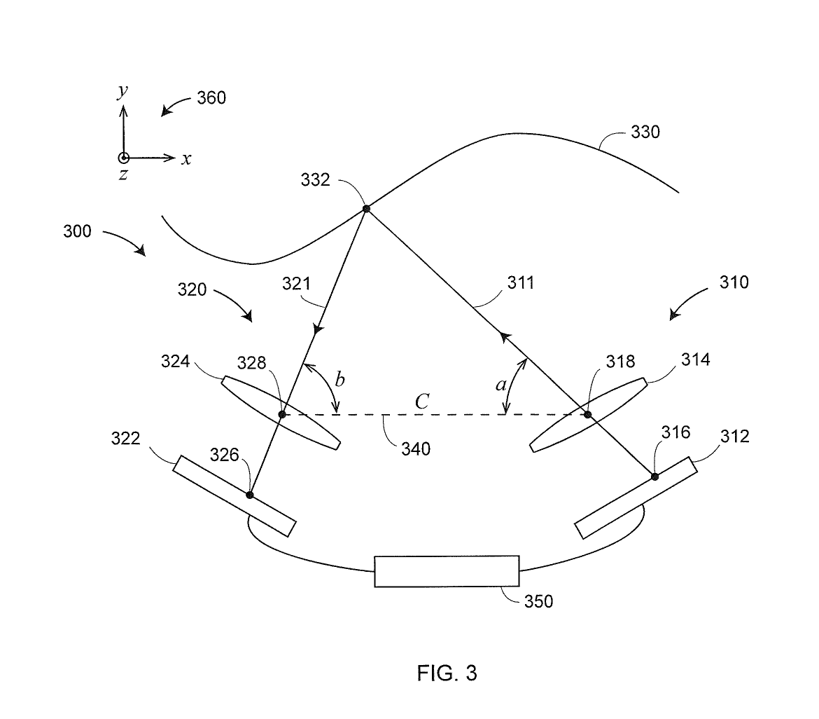

FIG. 3 shows a structured light triangulation scanner 300 that projects a pattern of light over an area on a surface 330. The scanner 300, which has a frame of reference 360, includes a projector 310 and a camera 320. In an embodiment, the projector 310 includes an illuminated projector pattern generator 312, a projector lens 314, and a perspective center 318 through which a ray of light 311 emerges or is emitted. The ray of light 311 emerges from a corrected point 316 having a corrected position on the pattern generator 312. In an embodiment, the point 316 has been corrected to account for aberrations of the projector 310, including aberrations of the lens 314, in order to cause the ray to pass through the perspective center, thereby simplifying triangulation calculations.

The ray of light 311 intersects the surface 330 in a point 332, which is reflected (scattered) off the surface 330 and sent through a camera 320 that includes a camera lens 324 and a photosensitive array 322. The reflected light passes through the camera lens 324 to create an image of the pattern on the surface 330 on the surface of the photosensitive array 322. The light from the point 332 passes in a ray 321 through the camera perspective center 328 to form an image spot at the corrected point 326. The image spot is corrected in position to correct for aberrations in the camera lens 324. A correspondence is obtained between the point 326 on the photosensitive array 322 and the point 316 on the illuminated projector pattern generator 312. As explained herein below, the correspondence may be obtained by using a coded or an uncoded (sequentially projected) pattern. Once the correspondence is known, the angles a and b in FIG. 3 may be determined. The baseline 340, which is a line segment drawn between the perspective centers 318, 328, has a length C. Knowing the angles a, b and the length C, all the angles and side lengths of the triangle 328-332-318 may be determined. Digital image information is transmitted to a processor 350, which determines 3D coordinates of the surface 330. The processor 350 may also instruct the illuminated pattern generator 312 to generate an appropriate pattern. The processor 350 may be located within the scanner assembly, or it may be an external computer, or a remote server.

As used herein, the term “pose” refers to a combination of a position and an orientation. In embodiment, the position and the orientation are desired for the camera and the projector in a frame of reference of the 3D imager 300. Since a position is characterized by three translational degrees of freedom (such as x, y, z) and an orientation is composed of three orientational degrees of freedom (such as roll, pitch, and yaw angles), the term pose defines a total of six degrees of freedom. In a triangulation calculation, a relative pose of the camera and the projector are desired within the frame of reference of the 3D imager. As used herein, the term “relative pose” is used because the perspective center of the camera or the projector can be located on an (arbitrary) origin of the 3D imager system; one direction (say the x axis) can be selected along the baseline; and one direction can be selected perpendicular to the baseline and perpendicular to an optical axis. In most cases, a relative pose described by six degrees of freedom is sufficient to perform the triangulation calculation. For example, the origin of a 3D imager can be placed at the perspective center of the camera. The baseline C (between the camera perspective center and the projector perspective center) may be selected to coincide with the x axis of the 3D imager. They axis may be selected perpendicular to the baseline and the optical axis of the camera. Two additional angles of rotation are used to fully define the orientation of the camera system. Three additional angles or rotation are used to fully define the orientation of the projector. In this embodiment, six degrees-of-freedom define the state of the 3D imager: one baseline, two camera angles, and three projector angles. In other embodiment, other coordinate representations are possible.

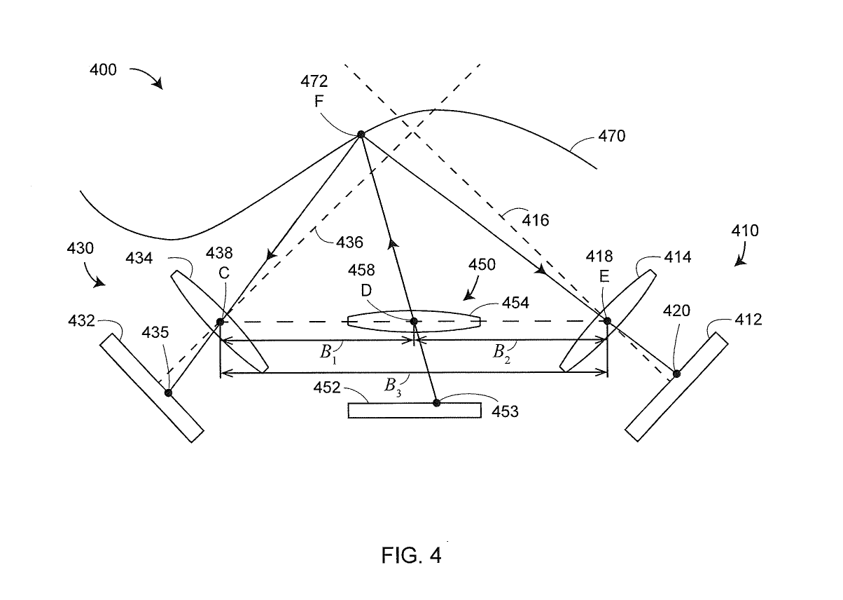

FIG. 4 shows a structured light triangulation scanner 400 having a projector 450, a first camera 410, and a second camera 430. In an embodiment, the projector creates a pattern of light on a pattern generator plane 452. A ray of light is projected from a corrected point 453 on the pattern generator plane 452 through the projector perspective center 458 (point D) of the lens 454 onto an object surface 470 at a point 472 (point F). The point 472 is imaged by the first camera 410 by receiving a ray of light from the point 472 through a perspective center 418 (point E) of a lens 414 onto the surface of a photosensitive array 412 as a corrected point 420. The point 420 is corrected in the read-out data by applying a correction factor to remove the effects of aberrations of lens 414. The point 472 is likewise imaged by the second camera 430 by receiving a ray of light from the point 472 through a perspective center 438 (point C) of the lens 434 onto the surface of a photosensitive array 432 of the second camera as a corrected point 435. The point 435 is similarly corrected in the read-out data by applying a correction factor to remove the effects of aberrations of lens 434.

The inclusion of two cameras 410 and 430 in the system 400 provides advantages over the device of FIG. 3 that includes a single camera. One advantage is that each of the two cameras has a different view of the point 472 (point F). Because of this difference in viewpoints, it is possible in some cases to see features that would otherwise be obscured in a single camera system—for example, seeing into a hole or behind a blockage. In addition, it is possible in the system 400 of FIG. 4 to perform three triangulation calculations rather than a single triangulation calculation, thereby improving measurement accuracy relative to the single camera system. A first triangulation calculation can be made between corresponding points in the two cameras using the triangle CEF with the baseline B₃. A second triangulation calculation can be made based on corresponding points of the first camera and the projector using the triangle DEF with the baseline B₂. A third triangulation calculation can be made based on corresponding points of the second camera and the projector using the triangle CDF with the baseline B₁. The optical axis of the first camera 420 is line 416, and the optical axis of the second camera 430 is line 436.

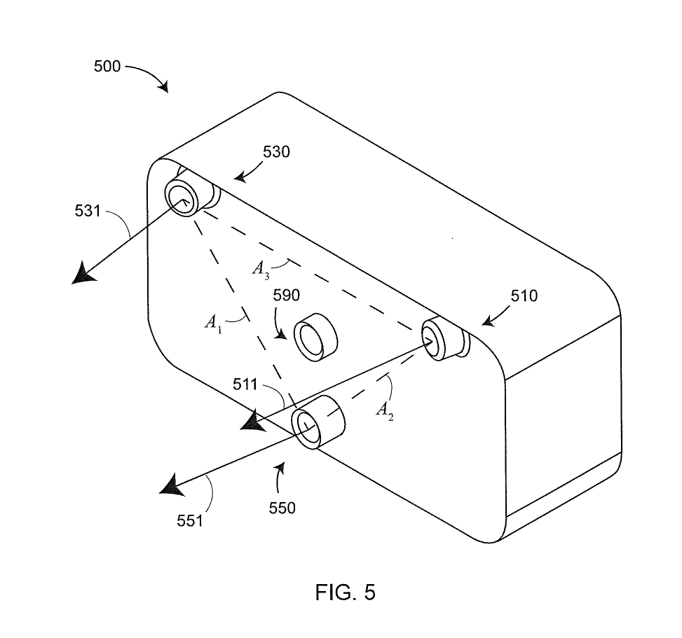

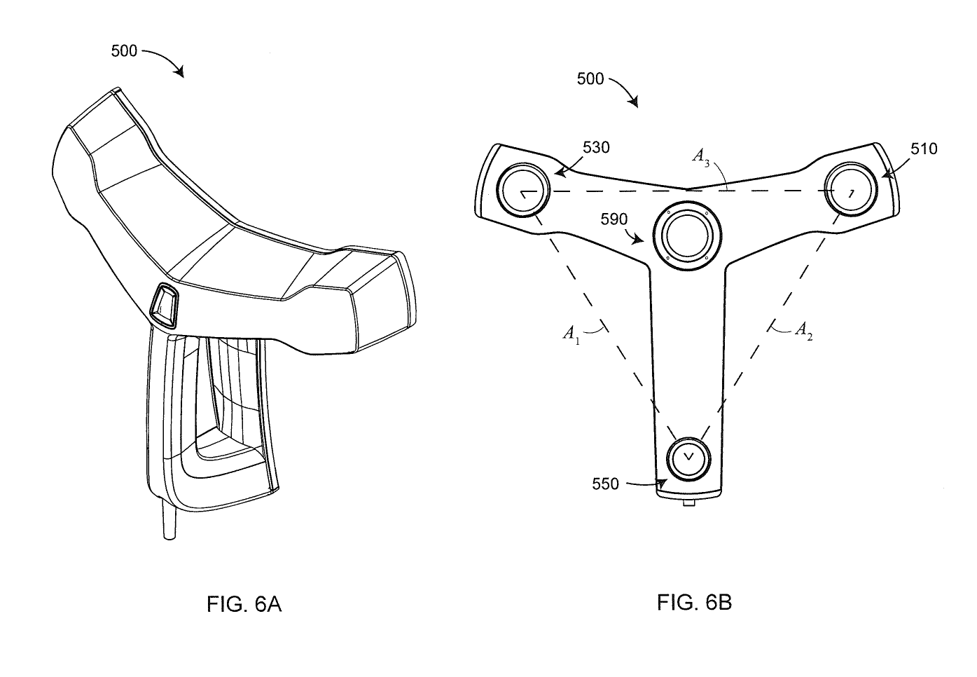

FIG. 5, FIG. 6A and FIG. 6B shows a triangulation scanner (also referred to as a 3D imager) 500 having two cameras 510, 530 and a projector 550 arranged in a triangle A₁-A₂-A₃. In an embodiment, the 3D imager 500 of FIG. 5 further includes a camera 590 that may be used to provide color (texture) information for incorporation into the 3D image. In addition, the camera 590 may be used to register multiple 3D images through the use of cardinal points (sometimes referred to as videogrammetry if the measured object is moving relative to the scanner 500). The lines 511, 531, 551 represent the optical axes of the camera 510, the camera 530, and the projector 550, respectively.

This triangular arrangement provides additional information beyond that available for two cameras and a projector arranged in a straight line as illustrated in FIG. 1 and FIG. 4. The additional information is provided through additional mathematical constraints provided by epipolar relationships among the projector 550 and the cameras 510, 530.

The scanner 500 may be a handheld scanner as illustrated in perspective and front views in FIGS. 6A, 6B, respectively. In an embodiment, the projector 550 projects an uncoded pattern of light, the correspondence between the projector 550 and the cameras 510, 530 being determined using mathematical epipolar relations. In an embodiment, the camera 590 is a registration camera that registers multiples frames of data by matching successive cardinal points (using videogrammetry).

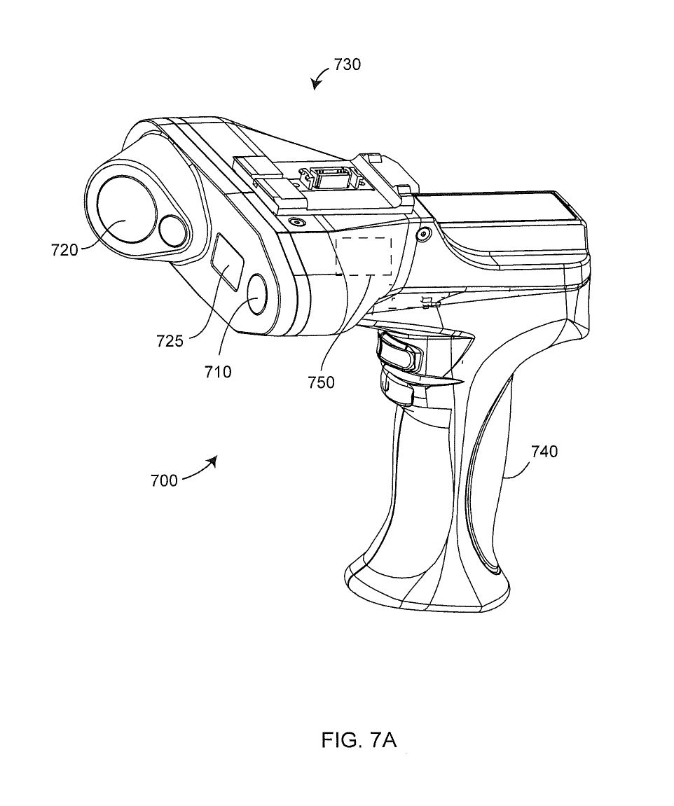

In an embodiment, a type of scanner 700 illustrated in the isometric view of FIG. 7A projects a line of light from a projector 710 onto an object. The reflected light on the object is imaged by a two-dimensional (2D) camera 720. In an embodiment, an additional optional camera 725 is further provided. This type of line scanner is sometimes referred to as a laser line probe (LLP) or as a triangulation line scanner. In an embodiment, the LLP 700 further includes an interface 730 that permits it to be attached to another device. In an embodiment, the LLP 700 includes a handle 740. In an embodiment, the LLP cooperates with a processor 750 to determine 3D coordinates of the object that receives the projected line of light based at least in part on projected light pattern and on the 2D image captured by the camera 710. The processor may include multiple electrical components, including memory, and may be located with the LLP or located external to it.

In an embodiment illustrated in the isometric view of FIG. 7B, the LLP 700 may be coupled through the interface 730 (FIG. 7A) to an articulated arm coordinate measuring machine (AACMM) 760 through an end effector 770 that includes a probe tip 775. The AACMM 760 includes a number of arm segments (also referred to as links) 780 attached by rotatable assemblies 785 that enable 3D measurements to be obtained by the probe tip 775 and by the LLP 700 coupled to the end effector 770.

In an embodiment illustrated in FIG. 7C, the LLP 700 is used in a handheld mode by coupling the LLP 700 though the interface 730 (FIG. 7A) to a stereo camera assembly 790 that includes a first camera 792A and a second camera 792B. In an embodiment, the stereo camera assembly 790 further includes lights 794A, 794B to illuminate features captured by the cameras 792A, 792B. The lights 794A, 794B may be disposed about the periphery of the cameras 792A, 792B respectively. In an embodiment, the LLP 700 and stereo camera assembly 790 are coupled to a processor 796, either internally or externally to the assemblies 700, 790. In an embodiment, the features captured in images acquired by the stereo camera assembly 790 are used to register multiple 3D images obtained by the LLP 700 into a common frame of reference.

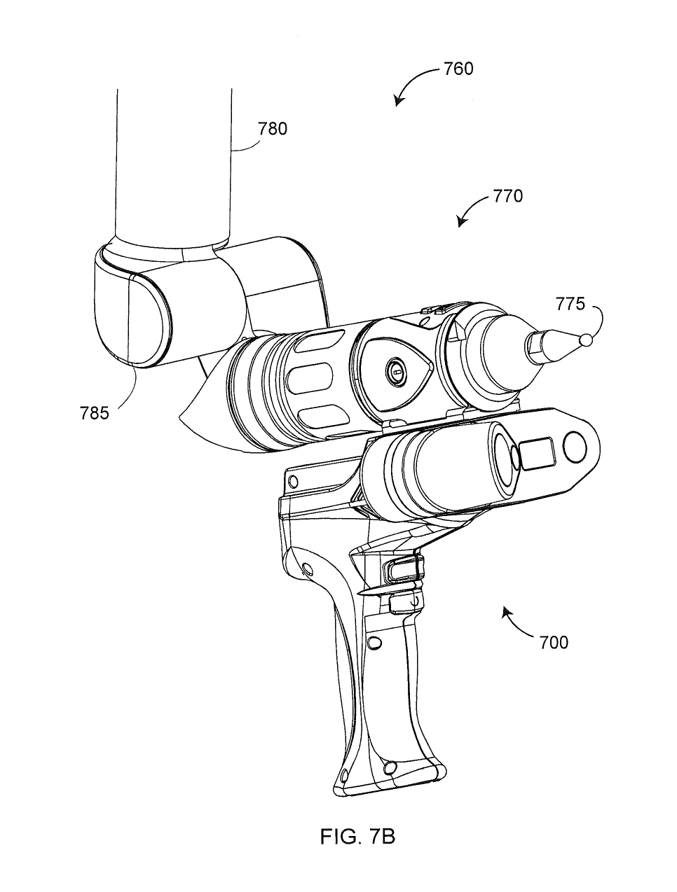

In an embodiment illustrated in FIG. 8A, a laser tracker 800 measures a retroreflector 805. In an embodiment, the laser tracker steers a beam of light 810 onto the center of the retroreflector 805. Part of the return light 812 travels to an absolute distance meter (ADM) that determines the distance from the tracker to the retroreflector based at least in part on the round-trip time to the retroreflector and on the speed of light in air. In an embodiment, the laser tracker 800 includes a stationary base assembly 820, a yoke assembly 825 that steers the beam of light about a first axis 827, and a payload assembly 830 that steers the beam of light about a second axis 832. In an embodiment, the laser tracker 10 includes a first angle-measuring device 835 that measures a first steering angle about the first axis 827 and a second angle-measuring device 840 that measures a second steering angle about the second axis 832. In an embodiment, the laser tracker 800 further includes one or more processors 845, which may include memory and communications circuits, in the tracker or outside the tracker.

In an embodiment illustrated in FIG. 8B, the laser tracker 800 is a six-DOF tracker that measures the six degrees-of-freedom of a six-DOF triangulation scanner 850. The six DOF triangulation scanner 850 includes one of more retroreflectors 855, a projector 860, and a camera 870. The projector 860 projects a pattern of light 862, either covering a point, a line, or an area, onto an object 875. The principle of operation of a triangulation scanner 850 was described herein above in reference to FIG. 3. The 3D coordinates of points on the object 875 are determined in a frame of reference of the six-DOF triangulation scanner 850 by a processor 880 based at least in part on the projected pattern of light 862 and the image of the pattern on the object 875 captured by the camera 870. It should be appreciated that the processor 880 may include one or more processors. These one or more processors may be disposed within or attached to the triangulation scanner 850 as illustrated or may be located remotely from the triangulation scanner 850. The laser tracker 800 sends the beam of light 810 to the retroreflector 855 and determines the 3D coordinates of the retroreflector 855 using methods described herein above in reference to FIG. 8A. The three orientational degrees-of-freedom of the six-DOF scanner 855 may be determined by any of a variety of methods. One such method involves capturing images of lights (not shown) on the six-DOF scanner 855 by a camera 802 on the six-DOF tracker.

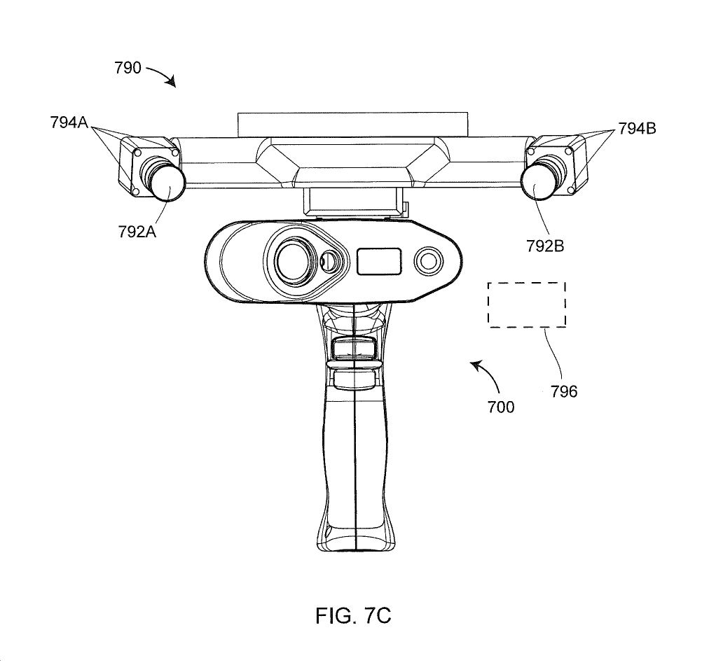

Referring now to FIGS. 9A, 9B, and FIG. 9C the isometric, front, and schematic views, respectively, of a TOF scanner 900. In an embodiment, a base 905 is stationary while a frame 910 rotates relatively slowly about a first axis 912 and a mirror 915 rotates relatively rapidly about a second axis 917. In an embodiment, the rotating mirror 915, which is angled at 45 degrees, and reflects or sends a beam 925 onto an object 902, with the beam direction determined by the angle of rotation of the mirror 915 about the second axis 917 as well as the angle of rotation of the frame 910 about the first axis 912. In an embodiment, the beam of light is generated by a light source 920 reflects off a dichroic beam splitter 922, reflects off the rotating mirror 915 and travels to the object 902. The reflected or scattered light 927 reflects off the rotating mirror 915. In an embodiment, visible light passes through the dichroic beam splitter 922 and passes to a central color camera 930. The reflected light 927 passes through an optical system 935 having a relatively large entrance aperture. In an embodiment, the optical elements in the optical system 935 include a relatively large glass lens and a collection of lenses. In an embodiment, the light passes from the optical system to an optical receiver 940 that operable, in conjunction with a processor 945, to determine a distance d from the TOF scanner 900 to the object 902 based at least in part on the speed of light in air. The TOF scanner 900 further includes a first angle-measuring device 950 that determines the angle of rotation of the frame 910 about the first axis 912 and a second angle-measuring device 955 that determines the angle of rotation of the rotating mirror 915 about the second axis 917.

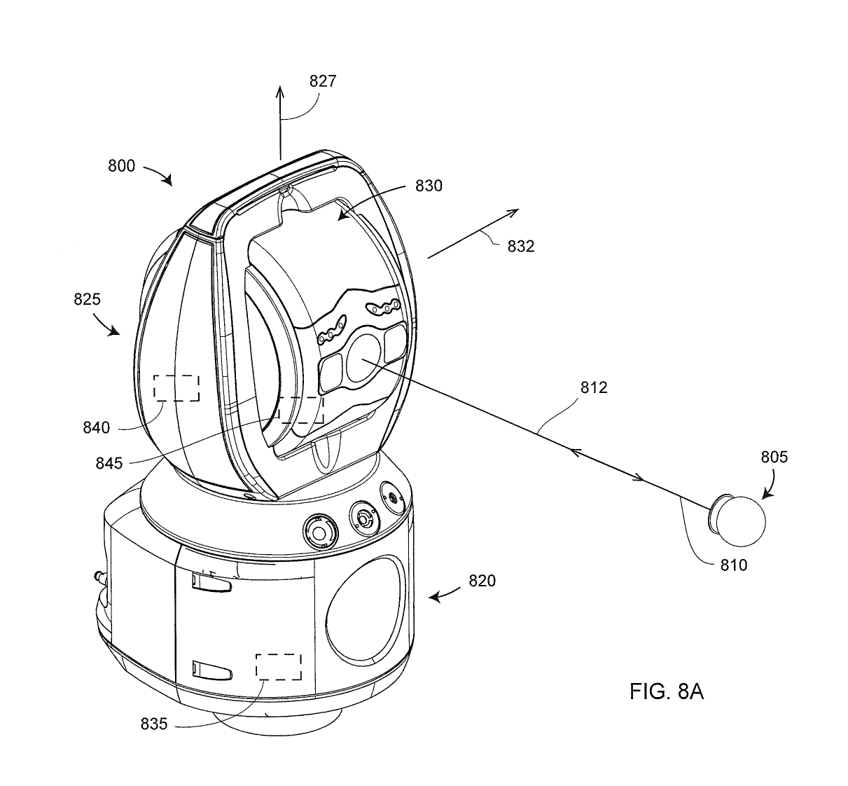

FIG. 10 is a schematic illustration showing an example of multipath interference, an effect that may degrade accuracy of 3D measurements of optical measurement system such as those described herein. In an embodiment, a triangulation scanner 1000 includes a projector 1010 having a pattern generator 1012 and a lens system 1015 with a perspective center 1017. A light from a corrected point 1013 on the surface of the pattern generator 1012 passes through the perspective center 1017 as a ray of light 1019 and intersects an object 1020 at a point 1022. In an embodiment, the ray of light 1019 reflects off the point 1022 and intersects the object 1020 at a second point 1024. The reflected light resulting from the double bounce off the points 1022 and 1024 is referred to herein as a secondary reflection. At the same time or simultaneously therewith, a ray of light 1026 from the pattern-generator point 1014 directly reaches and scatters off the point 1024. Light directly scattering (reflecting) off the point 1024 in a single bounce is referred to herein as a primary reflection. Mixing of primary and secondary reflections results in a phenomena known as multipath interference, which reduces measurement accuracy of the determined 3D coordinate of the point 1024. The ray of light 1030 reflected from the point 1024 arrives at a camera 1040 that includes a lens system 1042 with a perspective center 1044 and a photosensitive array 1046. The corrected point 1048 on the photosensitive array is thus contaminated by secondary reflections and hence is likely to have larger-than-expected error in 3D coordinates determined by a processor 1050 that performs the triangulation calculation.

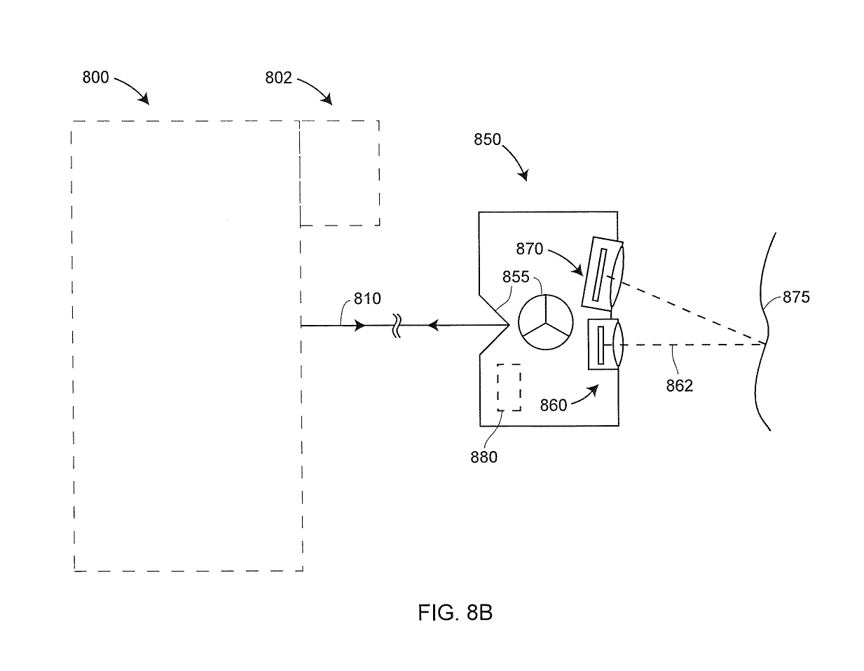

FIG. 11A and FIG. 11B illustrate the effects of placing circular polarizers on a projector and a camera in a triangulation scanner system. The triangulation scanner system 1100 of FIG. 11A includes a projector 1110 having a circular polarizer 1112. The circular polarizer 1112 may be a left-hand circular polarizer (left-handed) or a right-hand circular polarizer (right-handed). In an embodiment illustrated in FIGS. 11A, 11B, the circular polarizer 1112 is left-handed. The triangulation scanner system 1100 of FIG. 11A further includes a camera 1120 having a circular polarizer 1122 that is right-handed. The ray 1114 from the projector 1110 intersects the surface of an object 1130 at a point 1132. The light reflects off the surface in a ray 1116 that travels toward the camera 1120. For the rotational direction 1115 of the circular polarization of the ray 1114 indicated in FIG. 11A, the circularly polarized light is said to be left circularly polarized (LCP or left-handed) if the polarization appears to rotate in a corkscrew pattern that follows the fingers of the right hand when the thumb of the right hand is pointed in the direction of propagation of the light. The polarization is said to be right circularly polarized (RCP) if the right hand gives the desired corkscrew rotation. For the case illustrated in FIG. 11A, the light traveling along the ray 1114 is LCP and the polarizer 1112 is a left-handed polarizer.

For many materials, the light reflecting off the surface 1130 continues to rotate in the same direction following reflection. However, because the direction of propagation changes upon reflection, the handedness of the circularly polarized light reverses. So if the light is initially LCP, upon reflection the light is RCP. This may be seen from FIG. 11A by noting that the fingers of the left hand give the indicated rotation 1115 of the ray 1114 and the fingers of the right hand gives the indicated rotation 1117 of the ray 1116. For this choice of left-hand polarizer 1112 and right-hand polarizer 1122, almost all of the reflected light passes through the polarizer 1122 into the camera 1120.

FIG. 11B illustrates a triangulation scanner system 1150 that includes the projector 1110, which has a left-hand circular polarizer 1112 as in FIG. 11A. However, in the system 1150, a camera 1140 includes a polarizer 1142 that is a left-hand polarizer. In this case, the RCP reflected light is blocked by the left-handed polarizer 1142. For the case illustrated in FIG. 11A, the polarizers 1112 and 1122 are said to have opposite handedness. The light will also pass into the camera 1120 if the circular polarizer 1112 is right-handed and the circular polarizer 1122 is left-handed. In other words, the reflected light is passed into the camera 1120 as long as the polarizer 1112 for the projector 1110 and the polarizer 1112 for the camera 1120 have opposite handedness. Likewise, the reflected light is blocked from passing into the camera 1140 as long as the polarizer 1112 for the projector 1110 and the polarizer 1142 for the camera 1140 have the same handedness.

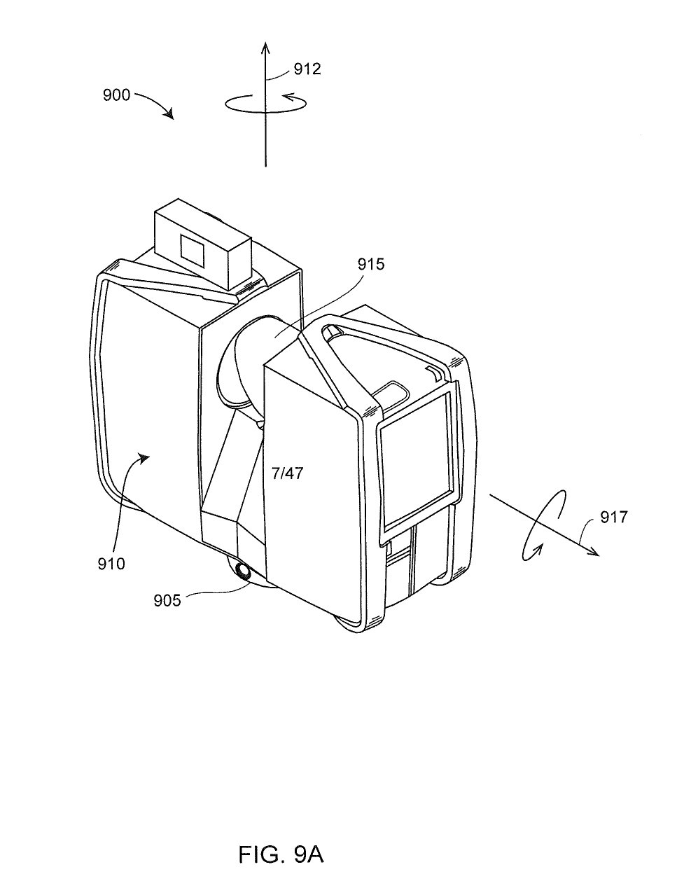

FIG. 12A and FIG. 12B illustrate the effects of placing circular polarizers on a projector and a camera on secondary reflections in a triangulation scanner system. In this embodiment, the triangulation scanner systems 1100, 1150 include the same elements as in FIGS. 11A, 11B—the same projectors, cameras, and polarizers. The object 1230 includes a feature 1234 that is intersected by a secondary ray 1214 from camera 1110 that reflects off a point 1236 in a first bounce and off the point 1132 in a second bounce before joining the ray 1114 (FIG. 11A, FIG. 11B) in a new composite ray 1216 that includes both the primary reflection and the secondary reflection. FIGS. 12A, 12B show that the indicated rotation 1217 of the secondary reflection within the composite ray 1216 is opposite the indicated rotation 1117 of the primary reflection within the composite ray 1216. It should be appreciated that the composite ray 1216 includes rays of light have LCP and RCP properties. The result of this difference in the handedness of the circular polarization is to block the secondary reflection from passing the circular polarizer 1122 to enter the camera 1120. In other words, in a camera 1110 with a circular polarizer 1112 having a handedness opposite the circular polarizer 1122 on a projector 1120 (FIG. 12A), the primary reflection passes through to the internal camera elements but the secondary reflection is blocked. On the other hand, in a camera 1110 with a circular polarizer 1112 having the same handedness as the circular polarizer 1142 on a projector 1140, the secondary reflection passes to the internal camera elements but the primary reflection is blocked (FIG. 12B).

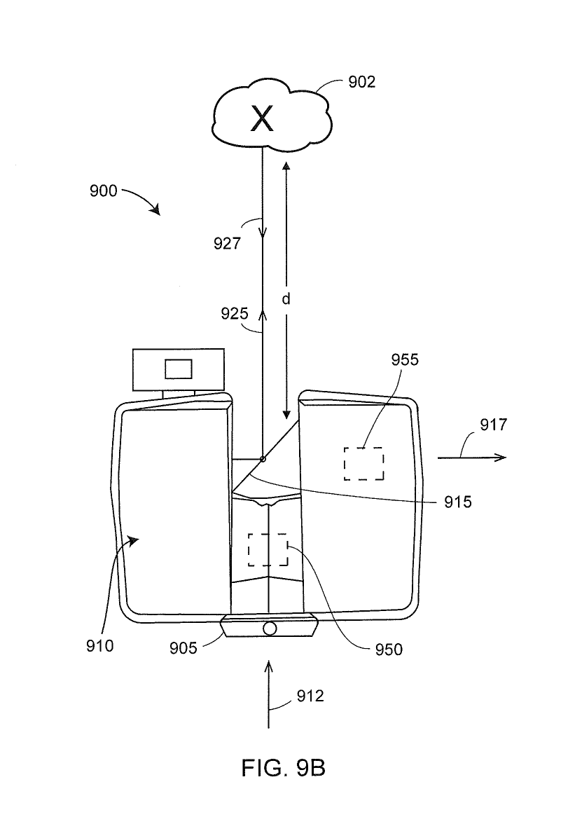

FIG. 13 shows the results of a mathematical analysis that confirms the behavior of the triangulation scanner systems 1100, 1150 of FIGS. 11A, 11B as described herein above. The curve 1310 is a plot of transmittance of the primary reflected light of the ray 1114 in passing through a circular polarizer 1122 having a handedness opposite that of the circular polarizer 1112 of the projector 1110 (as in FIG. 11A), in an embodiment where the primary light has reflected off an object 1130 made of aluminum. The transmittance is plotted for angle of incidence of 0 to 90 degrees. For a triangulation system 10 shown in FIG. 1, the angle of incidence seldom exceeds 10-15 degrees. The curve 1310 shows that at these expected angles of incidence and for polarizers having opposite handedness, the transmittance of primary reflected light is high and nearly constant. Only when the angle of incidence exceeds around 50 degrees does the transmittance begin to drop appreciably.

The curve 1320 is a plot of transmittance of primary reflected light of the ray 1114 in passing through the circular polarizer 1142 having the same handedness as the circular polarizer 1112 of the projector 1110 (as in FIG. 11B), where the primary light has reflected off an object 1130 made of aluminum. The curve 1320 shows that for the expected angles of incidence and for polarizers 1132, 1142 having the same handedness, the transmittance of primary reflected light is low and nearly constant.

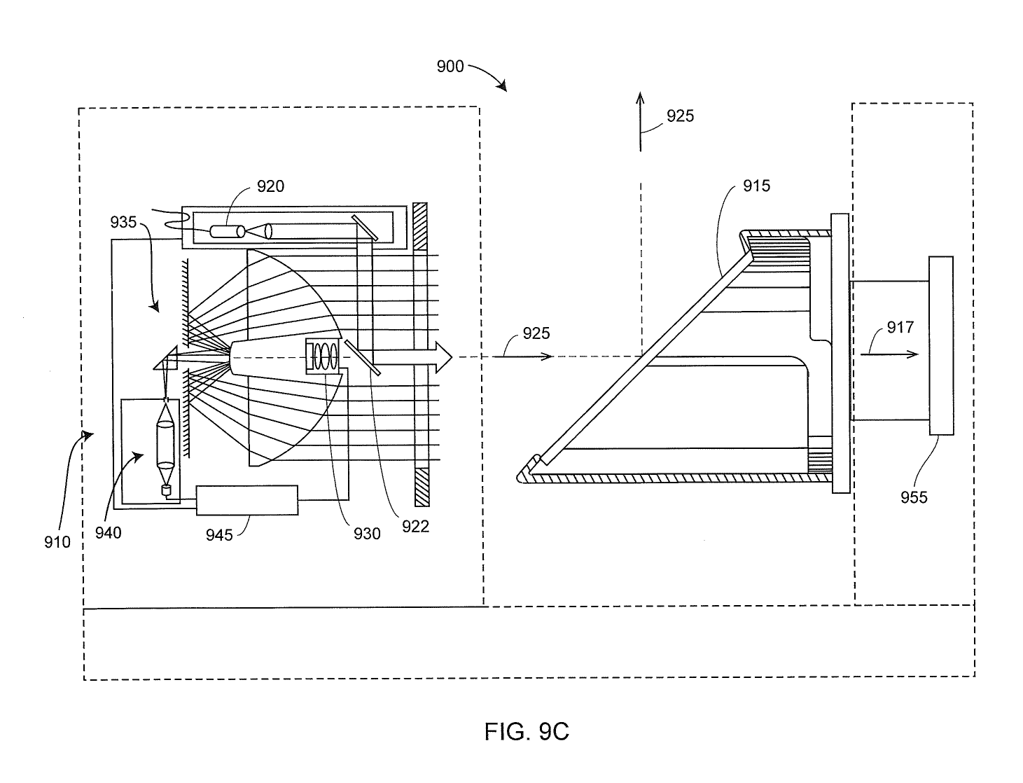

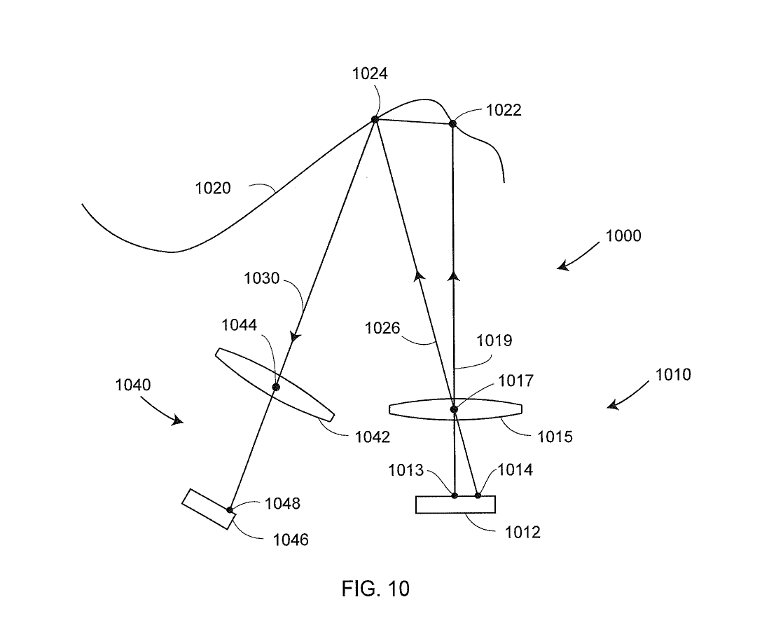

The expected results for the triangulation scanner systems 1100, 1150 of FIG. 12A and FIG. 12B is demonstrated experimentally in FIGS. 14A, 14B, 15A, and FIG. 15B. In FIG. 14A, the right panel of a two-panel L-bracket is illuminated, with a camera seeing primary reflections from the right panel and secondary reflections from the left panel. In FIG. 14A, no circular polarizers were placed in front of the projector or the camera. In FIG. 14B, the left panel of the L-bracket is again illuminated but with a left-handed circular polarizer placed in front of the projector and a right-handed circular polarizer placed in front of the camera. As expected, the secondary reflection is suppressed by the polarizers, which is to say that multipath interference has been suppressed. In FIG. 15A and FIG. 15B, the right panel of a bracket is again illuminated. In FIG. 15A, a left-handed circular polarizer is placed in front of the projector and a right-handed circular polarizer is placed in front of the camera, thus passing the primary reflections but suppressing the secondary reflections. In FIG. 15B, a left-handed circular polarizer is placed in front of both the projector and the camera. In this case, only the secondary reflections present on the left panel are passed and the primary reflections on the right panel are suppressed.

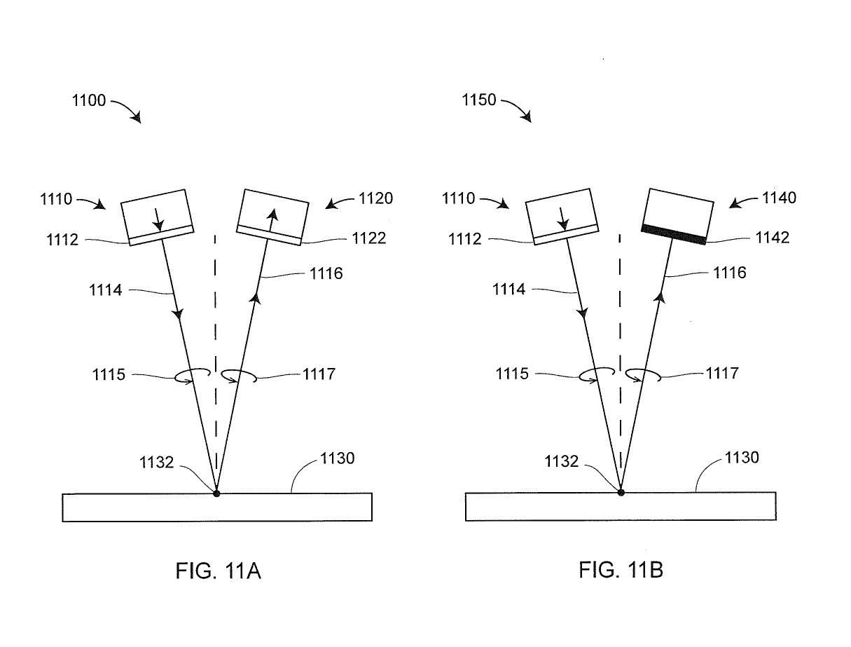

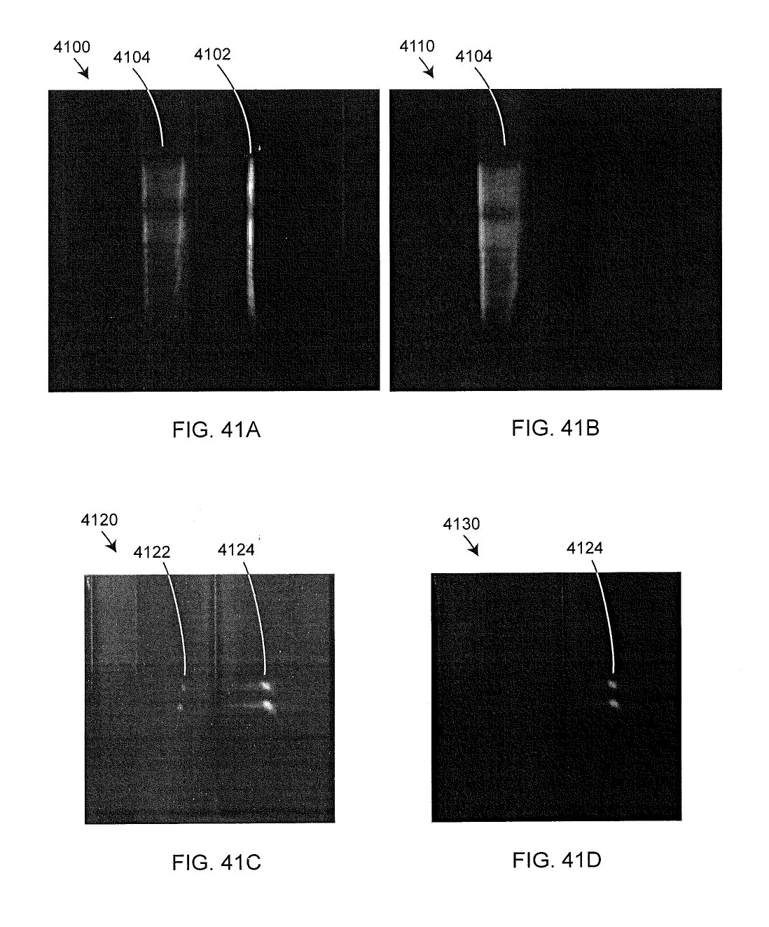

Referring now to FIG. 16A an embodiment is shown of a triangulation scanner 1610 that includes a scanner body 1620 to which are coupled a projector 1630, first triangulation camera 1660, second triangulation camera 1670, and reference camera 1640. In an embodiment, the projector further includes a polarizer assembly 1632 and the cameras 1660, 1670, 1640 further include polarizer assemblies 1662, 1672, 1642, respectively. In an embodiment, the each of the polarizer assemblies 1632, 1662, 1672, 1642 are removable polarizer assemblies that screw onto of otherwise couple to the bodies of the projector or camera bodies. In this situation, the polarizers may be used when desired and removed when not desired. In an embodiment, all the polarizers 1632, 1662, 1672, 1642 are circular polarizers with the polarizer 1632 having a first handedness, the polarizer 1642 having the same handedness as the polarizer 1632, and the polarizers 1662, 1672 having the opposite handedness as the polarizer 1632. In this configuration, the triangulation cameras 1662, 1672 suppress the unwanted secondary reflections, while the reference camera 1640 highlights the unwanted secondary reflections, thereby providing information that can be used to project light in patterns that reduce or minimize the undesired secondary reflections. This method is discussed further herein below in reference to FIGS. 42A, 42B, 42C, 42D, 42E, and FIG. 42F. It should be appreciated that in other embodiments the handedness of the polarizers may be changed on the three cameras 1662, 1672, 1642. It should also be appreciated that in other embodiments only a single camera may be used.

As explained herein above, in an embodiment, the polarizers are removed when not desired or are replaced by other polarizers to achieve a desired effect or extract desired information. In another embodiment, a mechanism is supplied to simplify changing of the polarization state. Referring to FIGS. 16B, 16C the front schematic and side schematic views of a camera or projector having a rotatable polarization assembly. In an embodiment, a camera or projector assembly 1680 includes a rotatable polarization assembly 1682, a lens assembly 1686, and a photosensitive array 1687 with support electronics. In an embodiment, the rotatable polarization assembly 1682 includes a plurality of polarization or glass elements such as elements 1683A, 1683B and a rotation mechanism such as elements 1684, 1685 that may include a shaft 1684 or a rotatable ring mechanism 1685 or other mechanism. The mechanism may permit rotation manually or through the use of a small motor. In an embodiment, the polarization assembly 1680 is relatively large and sits in front of the camera assembly, as illustrated in FIGS. 16B, 16C. In another embodiment, the polarization assembly is small and is internal to the lens assembly 1686 adjacent aperture 1688, or placed between the lens assembly 1686 and the photosensitive array 1687. In an embodiment, a first element 1683A is a circular polarizer having a first handedness. In an embodiment, a second element 1683B is a clear glass window. In a further embodiment, a second element 1683B is a circular polarizer having a second handedness opposite the first handedness. In a further embodiment, the polarization or glass elements comprises a plurality of elements that includes at least one additional element in addition to 1683A, 1683B, for example, the plurality of elements may include an RCP element, a LCP element and a clear element such as glass.

Referring now to FIG. 16D and FIG. 16E the front schematic and side schematic views of a camera or projector having a translatable polarization assembly. In an embodiment, a camera or projector assembly 1690 includes a translatable polarization assembly 1692, a lens assembly 1696, and a photosensitive array 1697 with support electronics. In an embodiment, the translatable polarization assembly 1692 includes a plurality of polarization or glass elements such as 1693A, 1693B and a linear translation mechanism such as 1695. The mechanism may permit translation manually or through the use of a small motor. In an embodiment, the polarization assembly 1690 is relatively large and sits in front of the camera assembly, as illustrated in FIG. 16D and FIG. 16E. In another embodiment, the polarization assembly is small and is internal to the lens assembly 1696 adjacent the aperture 1698, or placed between the lens assembly 1696 and the photosensitive array 1697. In an embodiment, a first element 1693A is a circular polarizer having a first handedness. In an embodiment, a second element 1693B is a clear glass window. In a further embodiment, a second element 1693B is a circular polarizer having a second handedness opposite the first handedness. In a further embodiment, the polarization or glass elements comprises a plurality of elements that includes at least one additional element in addition to 1693A, 1693B.

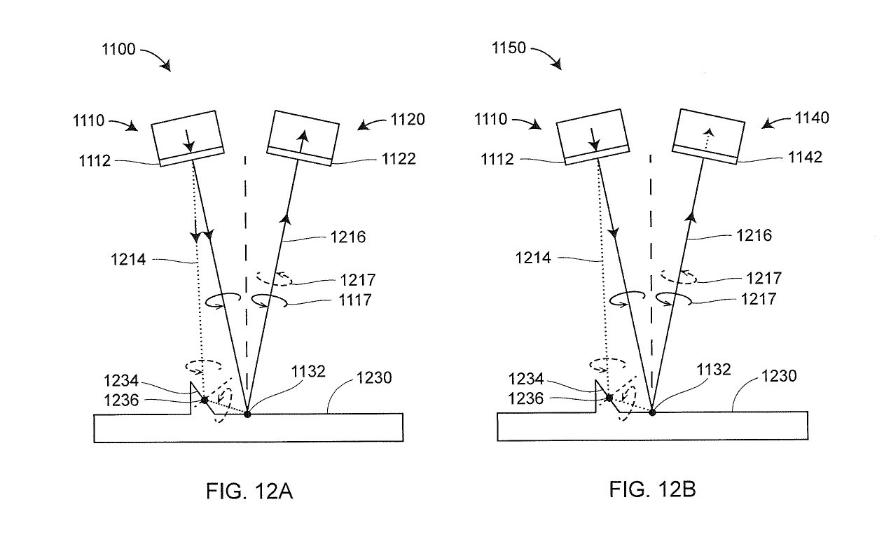

In an embodiment illustrated in FIG. 17, the laser tracker 800 is a six-DOF tracker that measures the six degrees-of-freedom of a six-DOF triangulation scanner 1750. The six-DOF scanner 1750 includes one of more retroreflectors 1755, a projector 1760, a triangulation camera 1770, and optionally a reference camera 1790. Similar to the discussion above with respect to FIG. 8B, the tracker 800 emits a light 1710 that is reflected off of the retroreflectors 1755, allowing the determination of position and pose of the scanner 1750. The three orientational degrees-of-freedom of the six-DOF scanner 1750 may be determined by any of a variety of methods. One such method involves capturing images of lights (not shown) on the six-DOF scanner 1750 by a camera 802 on the six-DOF tracker 800. In an embodiment, the projector 1760 projects a pattern of light 1762, which may be projected over a point, a line, or an area, onto an object 1775. In an embodiment, the projector 1760 further includes a circular polarizer 1761 having a first handedness, and the triangulation camera 1770 further includes a circular polarizer 1771 having a second handedness opposite the first handedness. The camera 1770 captures primary reflections from the surface 1775 but the unwanted secondary reflections are blocked from entering the camera 1770. In an embodiment, the six-DOF scanner 1750 further includes a reference camera 1790 having a circular polarizer 1792 with the same handedness as the circular polarizer on the projector 1760. The reference camera passes the unwanted secondary reflections from the surface of the object 1775 and assists in enabling determination of the parts of the surface of the object 1775 that produce the unwanted secondary reflections. The 3D coordinates of points on the object 1775 are determined in a frame of reference of the six-DOF triangulation scanner 1750 by a processor 1780 based at least in part on the projected pattern of light 1762 and the image of the pattern on the object 1775 captured by the camera 1771. It should be appreciated that the processor 1780 may include one or more processors. These one or more processors may be disposed within or attached to the triangulation scanner 1750 as illustrated or may be located remotely from the triangulation scanner 1750.

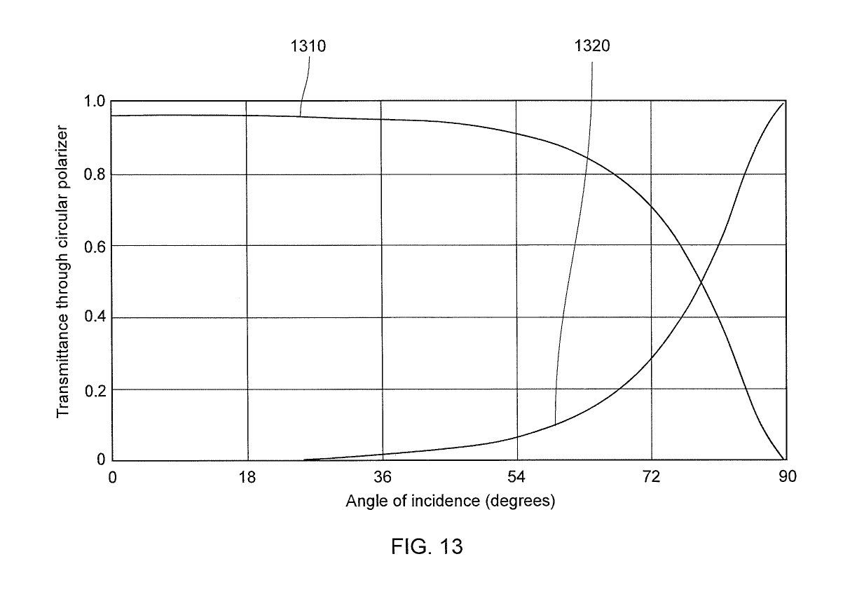

FIG. 18 illustrates an LLP 700 that further includes circular polarizer elements 1800 that eliminate or identify unwanted secondary reflections using circular polarizers as described herein above. Polarizer elements may be integrated into an assembly 1800 that, in an embodiment, includes circular polarizer elements 1800 coupled to the projector 710, the camera 720, and the camera 725. In an embodiment, the circular polarizer elements are removable. In a further embodiment, the polarizer elements are selectable, for example, using a small motor to rotate or translate desired polarizer or glass elements into place internal to the projector or camera structures of assembly 1800.

In an embodiment, a three-dimensional (3D) measurement system comprises: a processor system including at least one of a 3D scanner controller, an external computer, and a cloud computer operable for remote network access; a 3D measuring device including a projector operable to project a first light onto an object, the projector further including a first circular polarizer having a first handedness, the 3D measuring device receiving in response a first reflected light from the object, the 3D measuring device being operable to determine 3D coordinates of the object based at least in part on the projected first light and on the received first reflected light; and a polarization unit having a second circular polarizer and a reference camera, the second circular polarizer having a second handedness that is the same as the first handedness, the reference camera having a lens and photosensitive array, the polarization unit operable to measure on each pixel of a first collection of pixels of the photosensitive array a first light level of the first reflected light passed through a second circular polarizer, the processor system being operable to indicate a presence of first multipath reflection, the presence of first multipath reflection determined based at least in part on the measured first light level.

In another embodiment, in the 3D measurement system the processor system is further operable to display an image showing the presence of the first multipath reflection.

In another embodiment, in the 3D measuring system the projector is operable to project a second light onto the object at a first point for which the processor system did not indicate the presence of the first multipath reflection, to receive a second reflected light in response, and to determine 3D coordinates of the first point based at least in part on the projected second light and on the received second reflected light.

In another embodiment, in the 3D measurement system the 3D measuring device further includes a device camera; the projector is further operable to project a second patterned light onto a portion of the object for which the presence of the first multipath reflection was not indicated by the processor system; the device camera is operable to capture a second device image of the second patterned light on the object; and the processor system is further operable to determine 3D coordinates of a first point on the object based at least in part on the projected second patterned light and on the captured second device image.

In another embodiment, in the 3D measurement system: the projector of the 3D measuring device is further operable to project a second light onto a portion of the object for which the presence of the first multipath reflection was not indicated by the processor system; the 3D measuring device is further operable to receive a second reflected light in responses to the projected second light; and the polarization unit is further operable to measure on each pixel of a second collection of pixels of the photosensitive array a second light level of the second reflected light, the processor system being further operable to indicate a presence of second multipath reflection based at least in part on the measured second light level.

In another embodiment, in the 3D measurement system the projector is further operable to project a third light onto a second point on the object for which the processor system had neither indicated the presence of the first multipath reflection nor indicated the presence of the second multipath reflection; the 3D measuring device is further operable to receive a third reflected light in response to the projected third light; the processor system further operable to determine 3D coordinates of the second point based at least in part on the projected third light and on the received third reflected light.

In another embodiment, in the 3D measurement system the 3D measuring device further includes a device camera; the projector is further operable to project a third patterned light onto a portion of the object for which the processor system had neither indicated the presence of the first multipath reflection nor the presence of the second multipath reflection; the device camera is operable to capture a third device image of the third patterned light on the object; and the processor system is further operable to determine 3D coordinates of a second point on the object based at least in part on the projected third patterned light and on the captured third device image.

In another embodiment, a method for measuring three-dimensional (3D) coordinates comprises: providing a processor system, a 3D measuring device, and a polarization unit, the processor system including at least one of a 3D scanner controller, an external computer, and a cloud computer operable for remote network access, the 3D measuring device including a projector, the projector including a first circular polarizer having a first handedness, the polarization unit having a second circular polarizer and a reference camera, the second circular polarizer having a second handedness that is the same as the first handedness, the reference camera having a lens and photosensitive array; projecting by the projector a first light onto an object and receiving by the 3D measuring device a first reflected light from the object; measuring on each pixel of a first collection of pixels of the photosensitive array a first light level of the first reflected light passed through the second circular polarizer; indicating by the processor system a presence of first multipath reflection, the presence of the first multipath reflection determined based at least in part on the measured first light level; and storing the first light level.

In another embodiment, in the method for measuring the 3D coordinates, the method further comprises displaying by the processor system an image showing the presence of the first multipath reflection.

In another embodiment, in the method for measuring the 3D coordinates, the method further comprises projecting by the projector a second light onto the object at a first point for which the processor system did not indicate the presence of the first multipath reflection; receiving by the 3D measuring device a second reflected light in response to the projected second light; and determining by processor system 3D coordinates of the first point based at least in part on the projected second light and the received second reflected light.

In another embodiment, in the method for measuring the 3D coordinates, the method further comprises providing a device camera in the 3D measuring device; projecting with the projector a second patterned light onto a portion of the object for which the presence of the first multipath reflection was not indicated by the processor system; capturing with the device camera a second device image of the second patterned light on the object; and determining by the processor system 3D coordinates of a first point on the object based at least in part on the projected second patterned light and on the captured second device image.

In another embodiment, in the method for measuring the 3D coordinates, the method further comprises projecting by the projector a second light onto a portion of the object for which the presence of the first multipath reflection was not indicated by the processor system; receiving by the 3D measuring device a second reflected light in response to the projected second light; measuring on each pixel of a second collection of pixels of the photosensitive array a second light level of the second reflected light passed through the second circular polarizer; and indicating by the processor system a presence of second multipath reflection based at least in part on the measured second light level.

In another embodiment, in the method for measuring the 3D coordinates, the method further comprises projecting with the projector a third light onto a second point on the object for which the processor system had neither indicated the presence of the first multipath reflection not the presence of the second multipath reflection; receiving with the 3D measuring device a third reflected light in response to the projected third light; and determining by the processor system 3D coordinates of the second point based at least in part on the projected third light and on the received third reflected light.

In another embodiment, in the method for measuring the 3D coordinates, the method further comprises providing the 3D measuring device with a device camera; projecting with the projector a third patterned light onto a portion of the object for which the processor system had neither indicated the presence of the first multipath reflection nor the presence of the second multipath reflection; capturing with the device camera a third device image of the third patterned light on the object; and determining by the processor system 3D coordinates of a second point on the object based at least in part on the projected third patterned light and on the captured third device image.

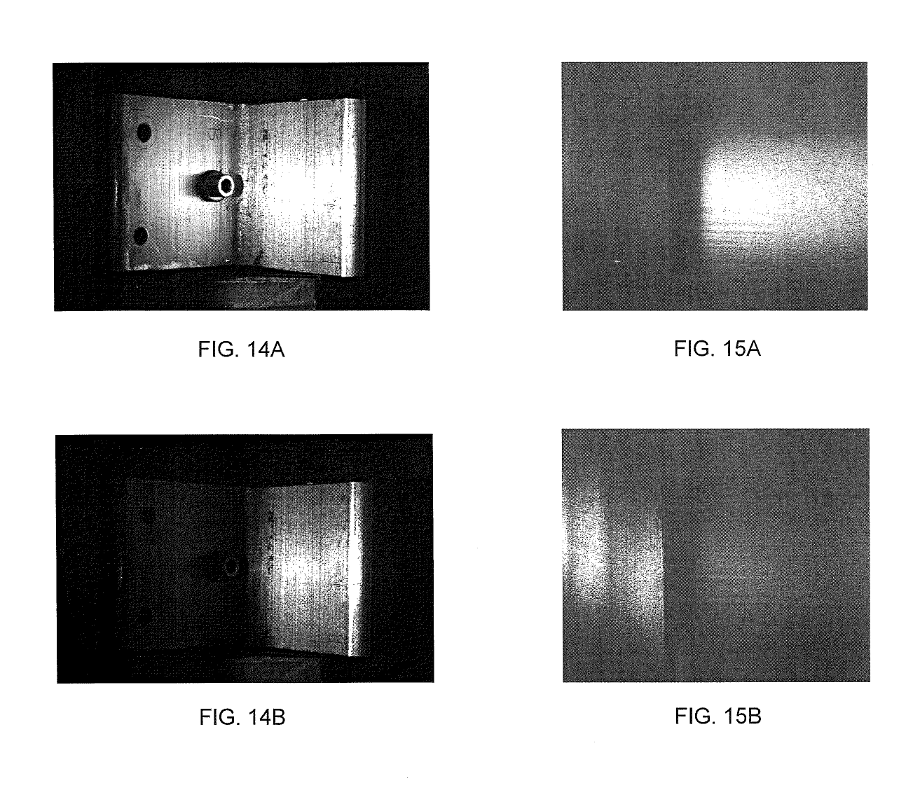

Different types of materials respond differently to polarized light. FIG. 19A shows a material 1900 having a smooth surface 1902 with a normal direction 1904. An incoming ray of light 1906 arrives an angle of incidence 1908 and is reflected as a ray of light 1910 at an angle of reflection 1912 equal to the angle of incidence 1908. Reflection in which a collimated beam of light on a surface reflects almost entirely in the same direction as in FIG. 19A is referred to as specular reflection. Such specular reflections may be seen, for example, in polished metal and in some dielectric materials.

FIG. 19B shows a material 1920 having a surface 1902 with a finish that has some surface roughness features 1921. An incoming ray of light 1926 arrives at an angle of incidence 1928 and reflects from a normal 1924 as a reflected ray 1930 having an angle of reflection 1932 equal to the angle of incidence 1926. However, because of the surface roughness, the direction of the normal 1924 varies from location to location on the surface 1922, resulting in reflection of a bundle of ray 1934 spread over a range of angles. This type of reflection or scattering is seen for example in metals having a matte finish following machining and it is also seen in some finished dielectric materials.

FIG. 19C shows a material 1940 having a surface 1942 that may be smooth or rough. Part of an incoming ray of light 1946 penetrates the surface 1942 and undergoes a scattering process 1947 that results in depolarization of the light. The emerging light has its polarization modified, at least slightly, by the Fresnel equations that govern refraction and reflection. The emerging ray of light 1950 will not in general have an angle of reflection equal to the angle of incidence. Such scattering processes are typically seen in dielectric materials rather than metals. However, scattered light from a dielectric material is usually not completely depolarized. Hence, to determine the changes in polarization state of dielectric materials, measurements with an actual material may be needed.

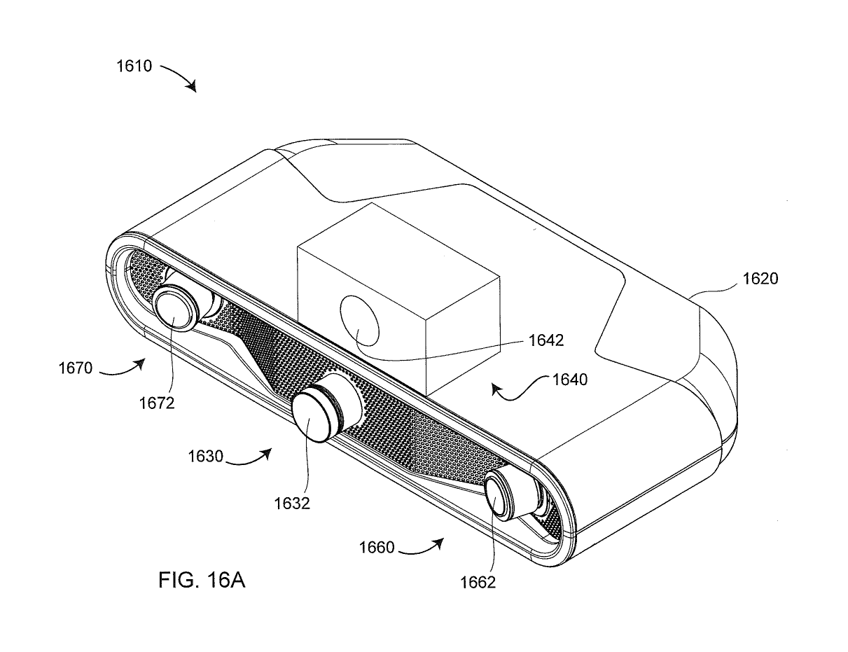

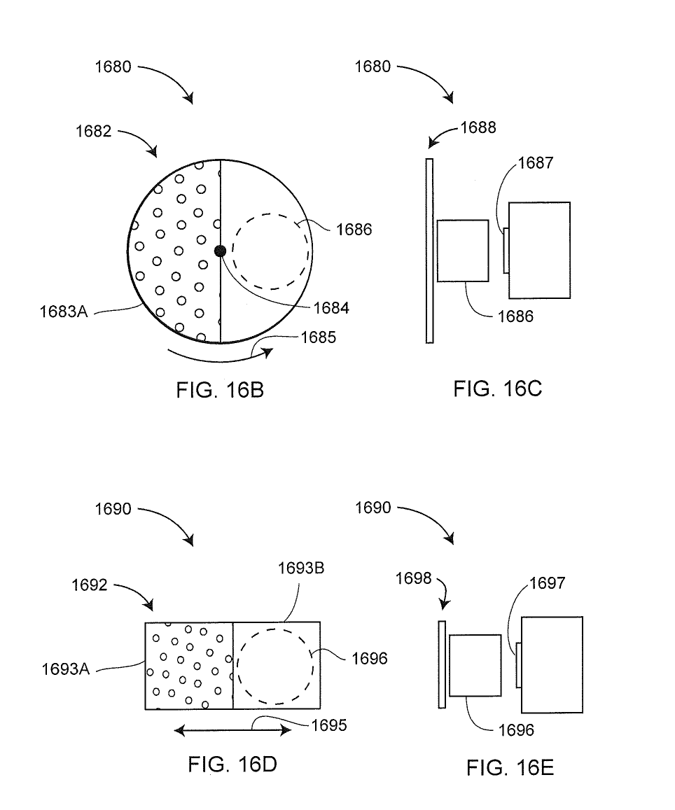

In an embodiment, three or more linear polarizers 2000, 2002, 2004, 2006 are provided as shown in FIGS. 20A, 20B, 20C, and FIG. 20D, which are used to capture a corresponding number of images of an object 2010, 2012, 2014, 2016, respectively, as shown in FIGS. 21A, 21B, 21C, 21D. In the embodiment illustrated in FIGS. 20A, 20B, 20C, 20D, the angles of linear polarization are 0, 45, 90, 135 degrees, respectively.

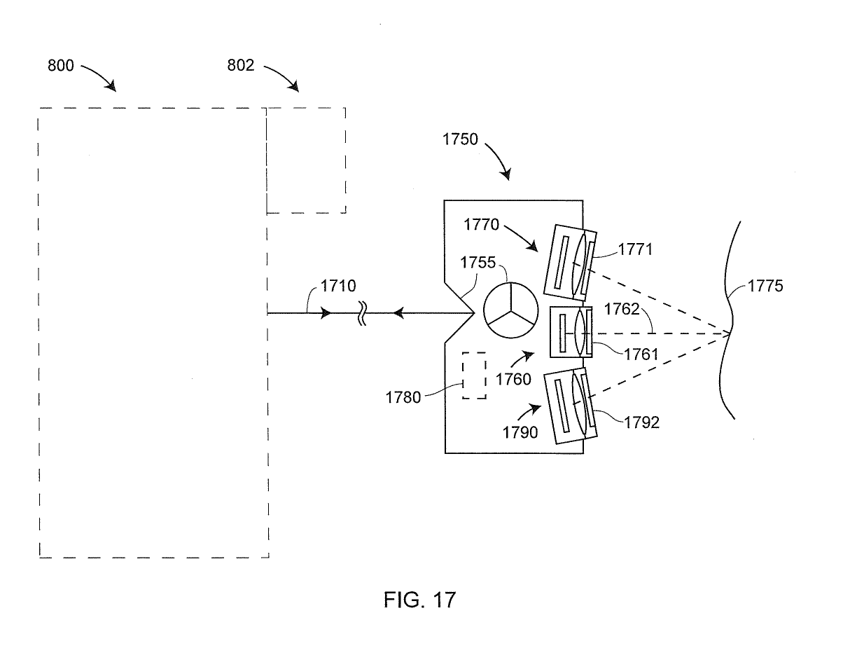

In an embodiment, the three or more polarization images 2010, 2012, 2014, 2016 may be combined to obtain an intensity image shown in FIG. 22A. In an embodiment, one way to extract normal vectors from the polarization images is to determine azimuth components of normal vectors based on a determined angle of polarization (AOP) for each pixel of the AOP image (FIG. 22C) and to determine zenith components of normal vectors based on a determined degree of polarization (DOP) for each pixel of the DOP image (FIG. 22B). A description of such calculations is given in Kadambi, et al., “Polarized 3D: High-quality depth sensing with polarization cues,” International Conference on Computer Vision, 2015, the contents of which are incorporated by reference herein.

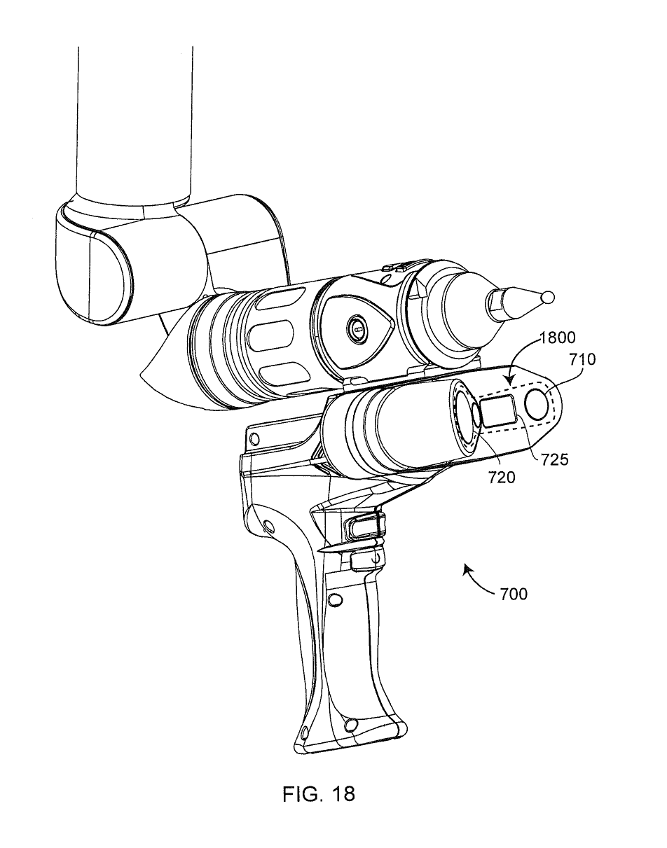

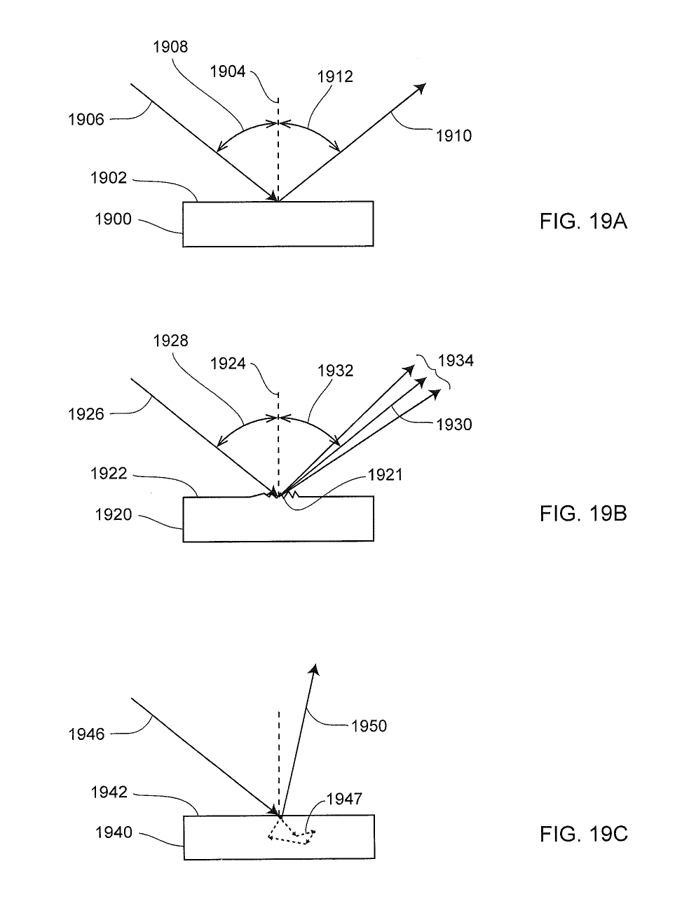

In an embodiment, a polarization unit 2310 is placed on a TOF scanner 2300, as shown in the isometric view of FIG. 23. In an embodiment, the polarization unit includes a polarizer assembly 2320, for which the dotted lines indicate that a variety of implementations are possible for the polarization assembly 2320. An embodiment of the polarization unit 2310 is shown in FIGS. 24A, 24B, 24C. In an embodiment, the polarizer assembly 2320 is the polarizer assembly 2420 of FIG. 24A. The polarizer assembly 2420 includes apertures 2422, 2424, 2426, 2428, each followed by a corresponding polarizer 2432, 2434 2436, 2438 (FIG. 24B), respectively. In an embodiment, the polarizers 2432, 2434, 2436, 2438 have corresponding polarizations 0, 90, 45, 135 degrees, respectively. In another embodiment, there are only three linear polarizers rather than four. The polarizers are positioned adjacent lenses and photosensitive arrays with supporting electronics. In an embodiment illustrated in the schematic side view FIG. 24C, the polarizer 2434 is positioned adjacent lens 2444 and photosensitive array 2454, and the polarizer 2438 is positioned adjacent lens 2448 and photosensitive array 2458.

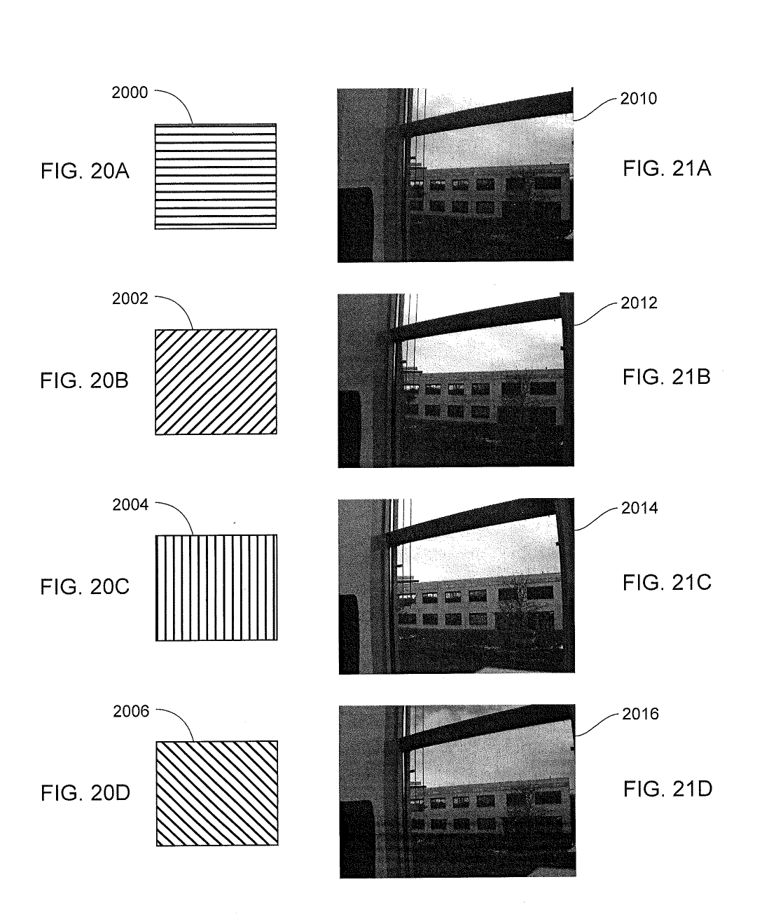

Referring now to FIGS. 25A-25C, FIGS. 26A-26B, FIGS. 27A-27C, FIGS. 28A-28E, FIG. 29, and FIGS. 30A-30C illustrate other embodiments of the polarizer assembly 2320. FIG. 25A illustrates a polarizer assembly 2530 that includes a linear polarizer 2532 and a rotation mechanism 2534 that enables rotation to three or more angles, either by motor or by hand. FIG. 25B illustrates an embodiment for a polarizer assembly 2540 that includes three or more linear polarizers 2542, 2544, 2546, 2548, each having a different angle of polarization. The polarizer assembly 2540 further includes a rotation mechanism 2549 for rotating the polarizers one at a time in front of or behind an aperture 2552. The polarizer assembly 2530 or 2540 is placed in front of camera assembly 2550 that includes aperture 2552, lens 2554, and photosensitive array 2556, which further includes support electronics. The camera assembly 2550 may further include an optical filter than passes selected wavelengths of light.

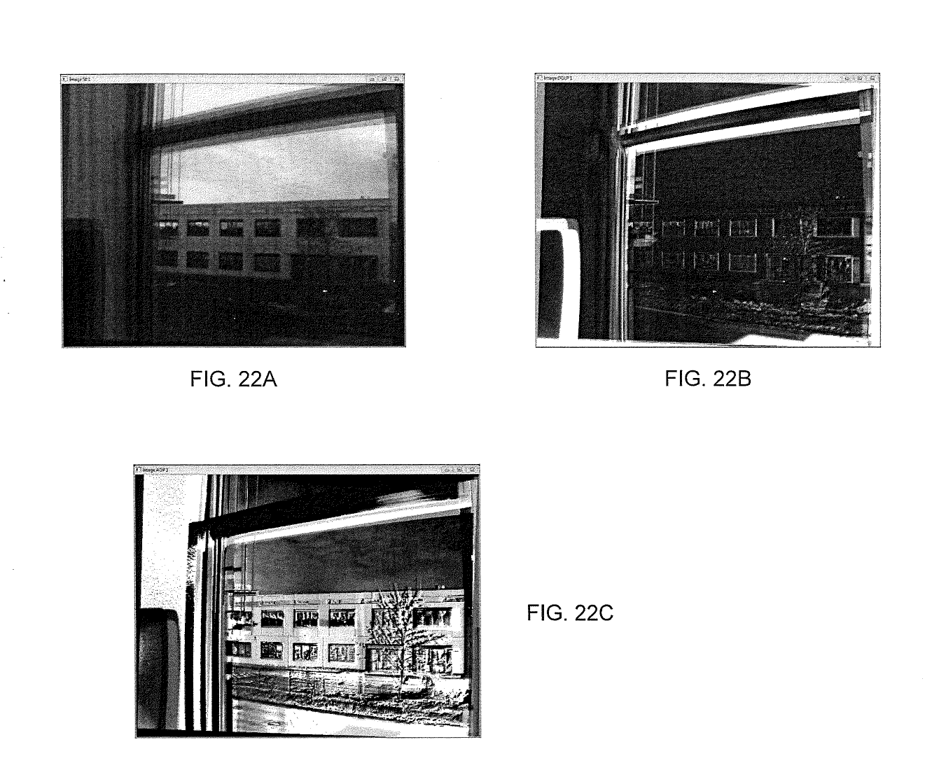

FIG. 26A illustrates a polarization assembly 2560 that includes three or more linear polarizers 2561, 2562, 2563, 2564, each having a different angle of polarization. The polarization assembly 2560 further includes a translation mechanism 2566 for translating the polarizers in front of the aperture 2552 of camera assembly 2550. The translation mechanism may by moved by motor or by hand.

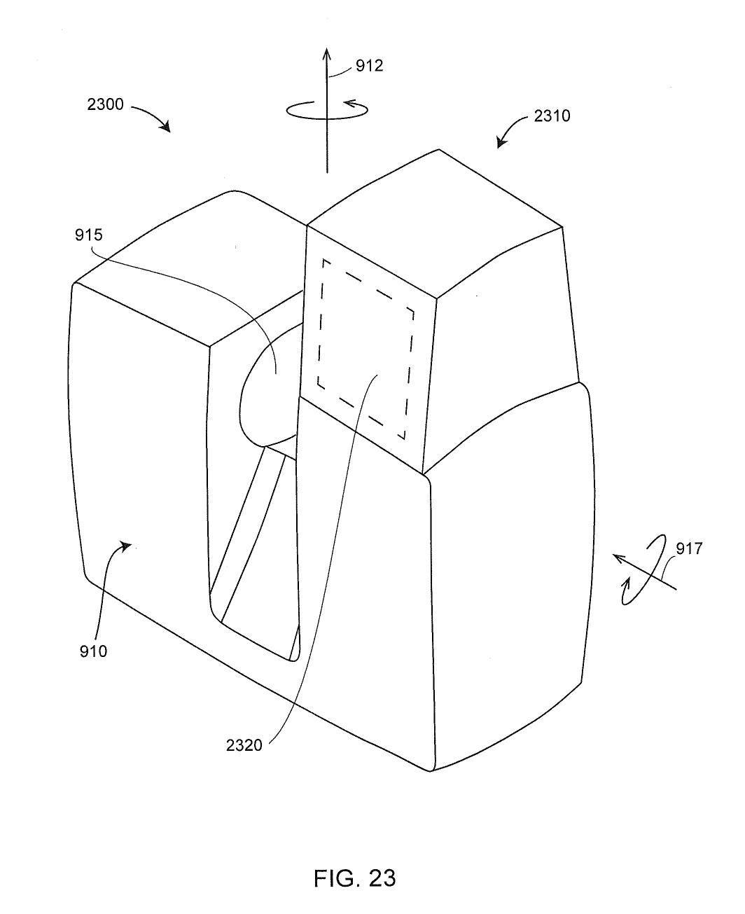

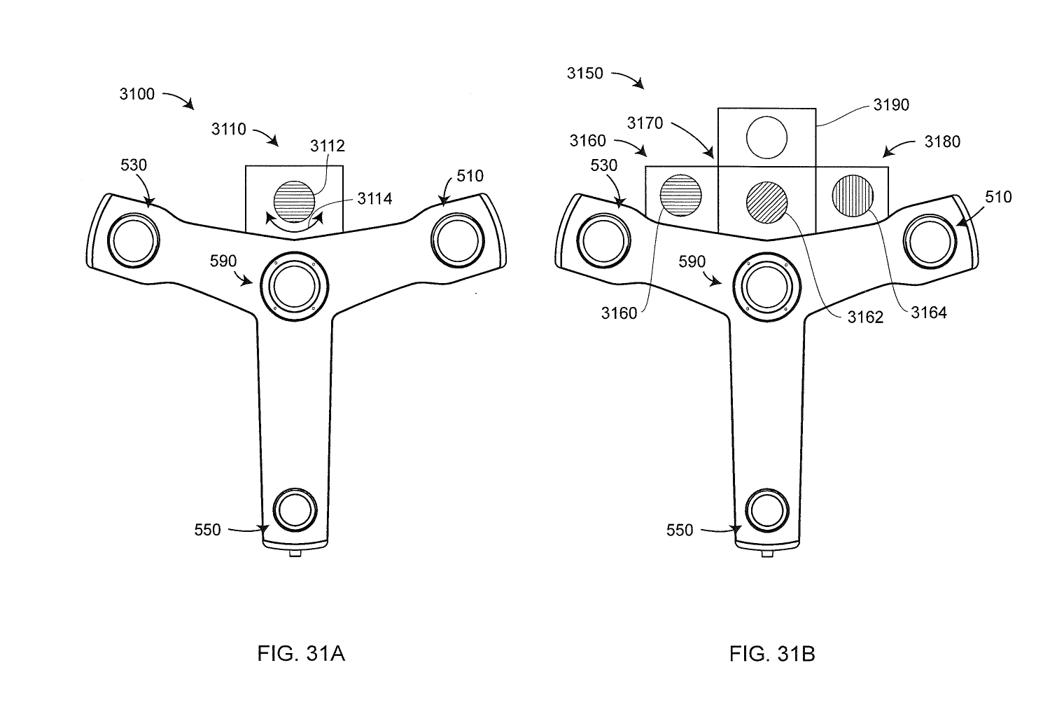

FIG. 27A illustrates a polarization assembly 2570 that includes three of more linear polarizers 2571, 2572, 2573 and in addition a clear glass element 2574. FIG. 27B illustrates a polarization assembly 2577 that includes a plurality of linear polarizers 2571, 2572, 2573, 2575. The polarization assemblies 2570, 2577 do not include rotation mechanisms but rather sit fixed in front of the aperture 2552 of the camera assembly 2550. The polarization assemblies 2570, 2577 might be used with a handheld scanner 3100 or 3150 shown in FIG. 31A and FIG. 31B. In normal operation, such a scanner so that most of the imaged regions are captured by each of the plurality of linear polarizers in the polarization assemblies 2570, 2577.

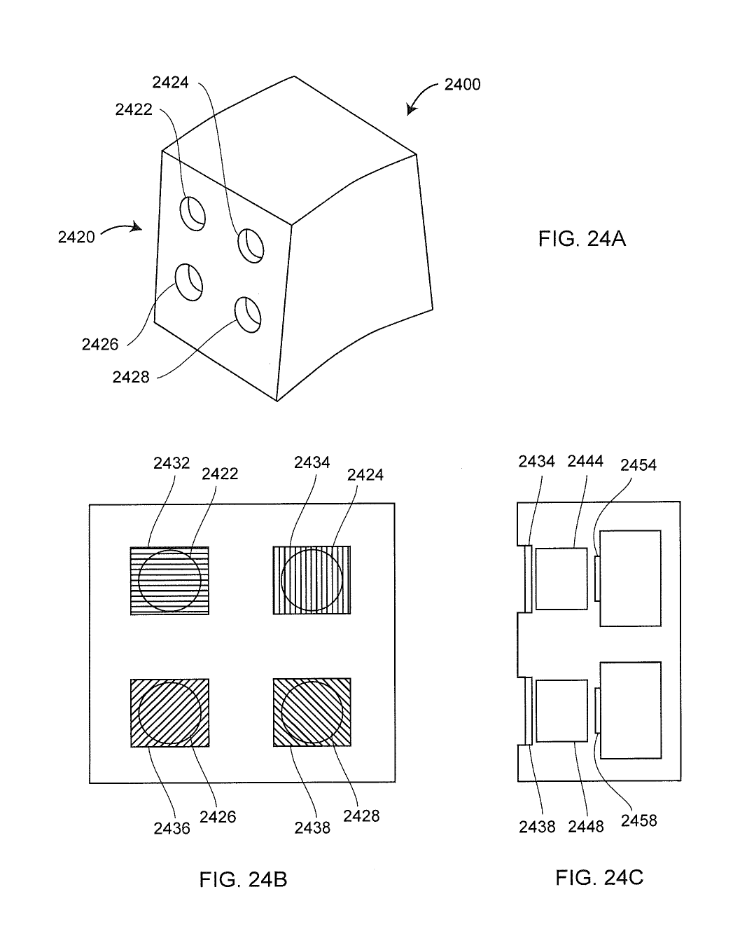

FIGS. 28A, 28B, 28C, 28D illustrate different polarization states 2581, 2582, 2583, 2584 obtained by an electro-optic assembly 2585 of a polarization unit 2580. In an embodiment, the electro-optic assembly 2585 includes a liquid-crystal polarizer and support elements. Further elements of the polarization unit 2580 include lens 2588 and photosensitive array 2589. The polarization unit 2580 may further include an optical filter than passes selected wavelengths of light. In an embodiment, the optical filter 2587 is applied as a coating to one or more lens elements. In another embodiment, the optical filter 2587 is included as a separate glass filter element.

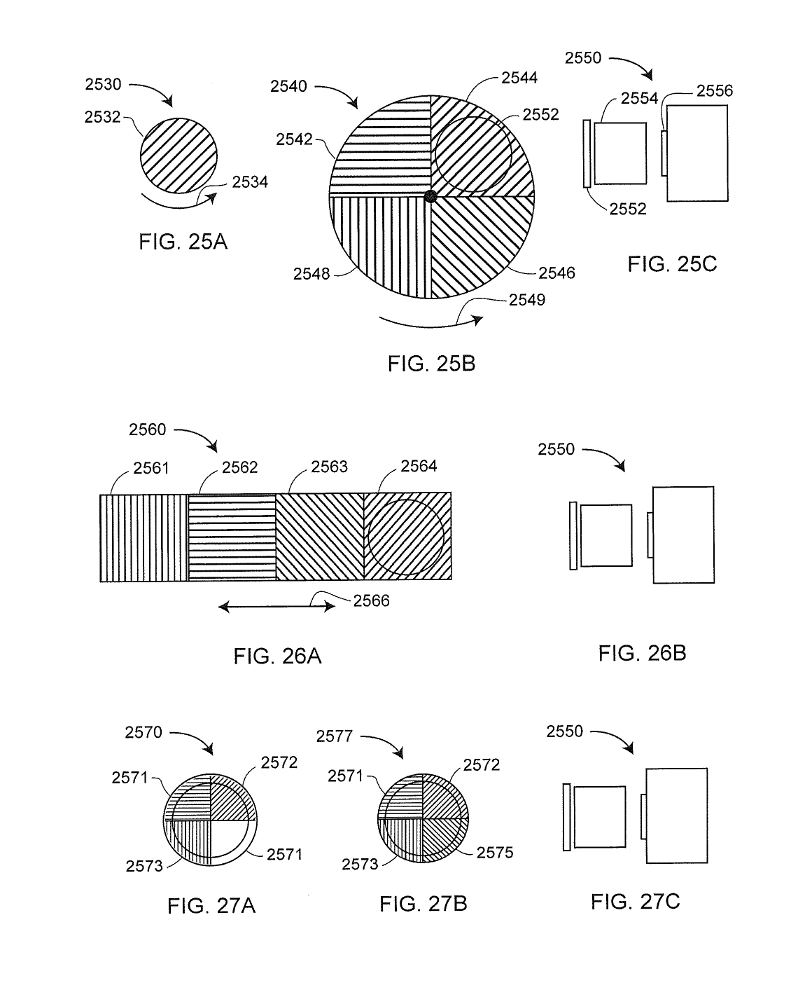

FIG. 29 is a polarization unit 2590 that includes a lens 2591, a beam-splitter prism 2592, three or more linear polarizing filters 2593A, 2593B, 2593C and three or more photosensitive arrays 2594A, 2594B, 2594C. The photosensitive arrays include support electronics. The polarization unit 2590 may further include an optical filter than passes selected wavelengths of light. In an embodiment, the optical filter 2587 is applied as a coating to one or more lens elements. In another embodiment, the optical filter 2587 is included as a separate glass filter element.

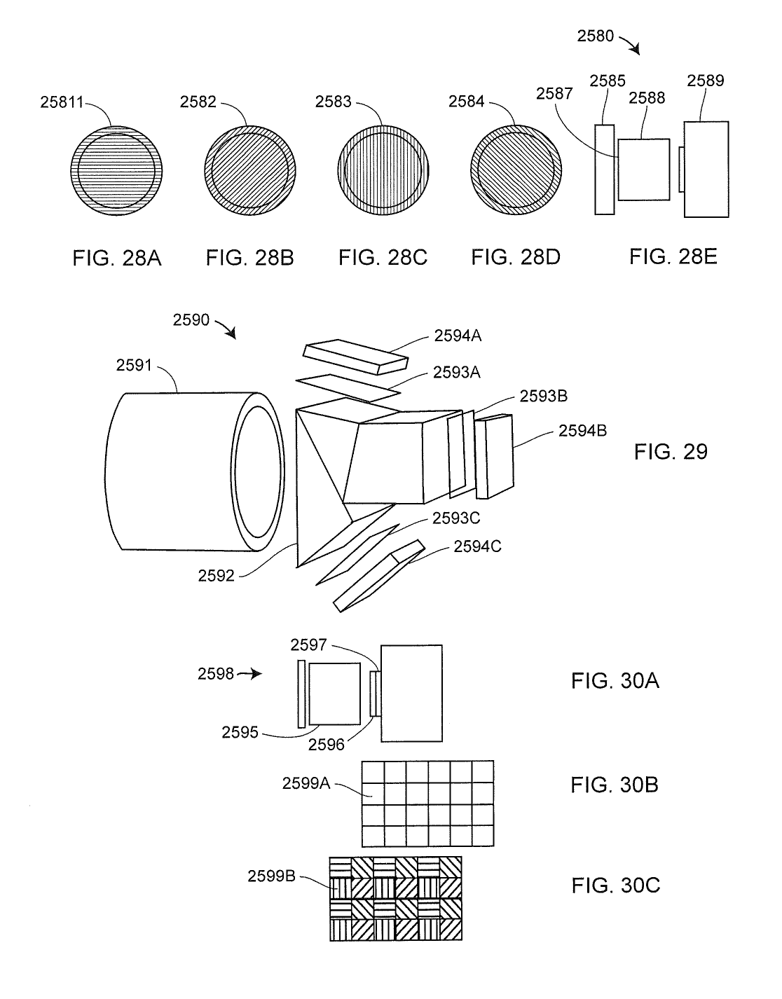

FIGS. 30A, 30B, 30C depict a camera/polarization unit 2598 having a lens 2595, a photosensitive array 2597, and a polarization grid 2596 placed between the lens 2595 and the photosensitive array 2597. In an embodiment, the polarization grid 2596 includes a plurality of small linearly polarized filters 2599B rotated to at least three different angles. FIG. 30B depicts a portion of the photosensitive array 2597 having pixel elements 2599A aligned to corresponding polarization filter elements 2599B of the polarization grid 2596, where elements of the polarization grid 2596 are aligned to pixels 2599A of a photosensitive array 2597. The camera 2598 may further include an optical filter that passes selected wavelengths of light.

FIGS. 31A, 31B are front views showing handheld scanners 3100, 3150, respectively. In an embodiment, which include cameras 510, 530, 590, and projector 550 as described herein above in reference to FIG. 5, FIG. 6A, and FIG. 6B. The handheld scanner 3100 includes a polarization unit 3110 that includes a linear polarizer and a rotation mechanism 3114 which may be motorized or manually controlled. In an embodiment, the polarizer 3112 may be rotated to give three or more different linear polarizations. Each of the linear polarizers is located in front of internal camera elements that include a lens (not shown) and a photosensitive array (not shown) with support electronics. The handheld scanner 3150 includes three or more polarization units 3160, 3170, 3180 and an optional light source 3190. The polarization units 3160, 3170, 3180 include linear polarizers 3162, 3172, 3182, respectively, oriented at different angles. Each of the linear polarizers is located in front of internal camera elements that include a lens (not shown) and a photosensitive array (not shown) with support electronics. In an embodiment, the optional light source 3190 may be operable to emit a plurality of different wavelengths of light. By emitting light at different wavelengths and viewing illuminated objects, additional aspects of the object such as object texture and composition may become apparent. Such illuminating and viewing capabilities are useful in the field of forensics investigation, for example.

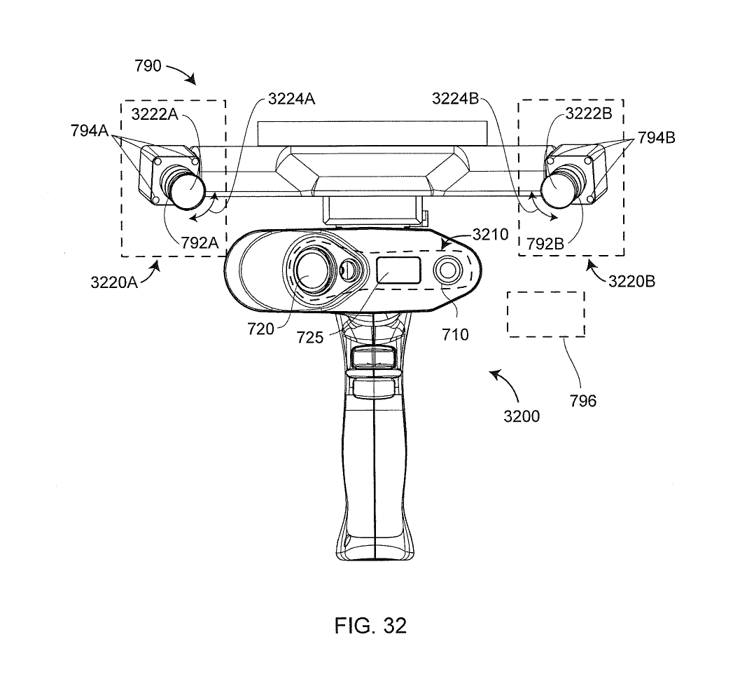

Referring now to FIG. 32 is a front view of an LLP 700 described in FIG. 7A is used in a mobile or portable handheld mode by coupling the LLP 700 though the interface 730 (FIG. 7A) to a stereo camera assembly 790 to define a coordinate measurement system 3200. The stereo camera assembly 790 includes a first stereo camera 792A and a second stereo camera 792B described in FIG. 7C. In an embodiment, a polarizer unit 3210 is added to at least one of the projector 710, the first scanner camera 720 and the second scanner camera 725. In an embodiment, the polarizer unit 3210 is coupled to the first scanner camera 720 through a rotatable lens attachment, with rotations possible through at least three angles. In another embodiment, the polarizers are included within the lens assembly and are rotatable through a motorized rotation stage. In another embodiment, the polarizer unit 3210 is coupled to the second scanner camera 725 rather than the first scanner camera 710. In another embodiment, the polarizer unit 3210 is coupled to both the first scanner camera 720 and the second scanner camera 725. In a further embodiment, a polarizer unit 3220A, 3220B is coupled to at least one of the first stereo camera 792A and the second stereo camera 792B, respectively. In an embodiment, the polarizer unit 3220A, 3220B includes a mechanism 3224A, 3224B, respectively, that rotates a linear polarizer 3222A, 322B, respectively, to three or more angles.

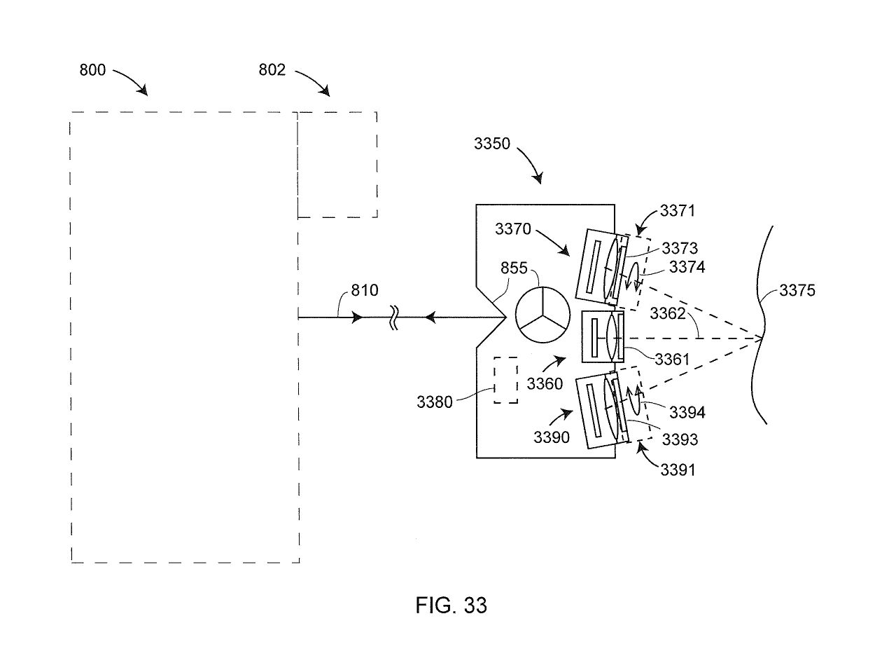

In an embodiment illustrated in FIG. 33, the laser tracker 800 is a six-DOF tracker that measures the six degrees-of-freedom of a six-DOF triangulation scanner 3350. The six-DOF scanner 3350 includes one or more retroreflectors 855, a projector 3360, a triangulation camera 3370, and optionally a reference camera 3390. Similar to the discussion above with respect to FIG. 8B, the tracker 800 emits a light 1710 that is reflected off of the retroreflectors 855, allowing the determination of position and pose of the scanner 3350. The three orientational degrees-of-freedom of the six-DOF scanner 3350 may be determined by any of a variety of methods. One such method involves capturing images of lights (not shown) on the six-DOF scanner 3350 by a camera 802 on the six-DOF tracker 800. In an embodiment, the projector 3360 projects a pattern of light 3362, which may be projected over a point, a line, or an area, onto an object 3375. In an embodiment, the projector 3360 includes a projector polarizing element 3361. In an embodiment, the triangulation camera 3370 further includes a first polarizer unit 3371 that includes a linear polarizer 3373 that may be rotated by a rotation mechanism 3374 to at least three different directions. The rotation mechanism 3374 and linear polarizer 3373 may be located on an exterior portion of the first polarizer unit 3371 or internal to the triangulation camera 3370. In an embodiment, the reference camera 3390 further includes a second polarizer unit 3391 that includes a linear polarizer 3393 that may be rotated by a rotation mechanism 3394 to at least three different directions. The rotation mechanism 3394 and linear polarizer 3393 may be located on an exterior portion of the first polarizer unit 3391 or internal to the reference camera 3390. In an embodiment, a processor 3380, which may be internal to or external to the six-DOF scanner 3350, assists in computations performed by the six-DOF scanner 3350. The 3D coordinates of points on the object 3375 are determined in a frame of reference of the six-DOF triangulation scanner 3350 by a processor 3380 based at least in part on the projected pattern of light 3362 and the image of the pattern on the object 3375 captured by the camera 3371, 3390 or a combination thereof. It should be appreciated that the processor 3380 may include one or more processors. These one or more processors may be disposed within or attached to the triangulation scanner 3350 as illustrated or may be located remotely from the triangulation scanner 3350.

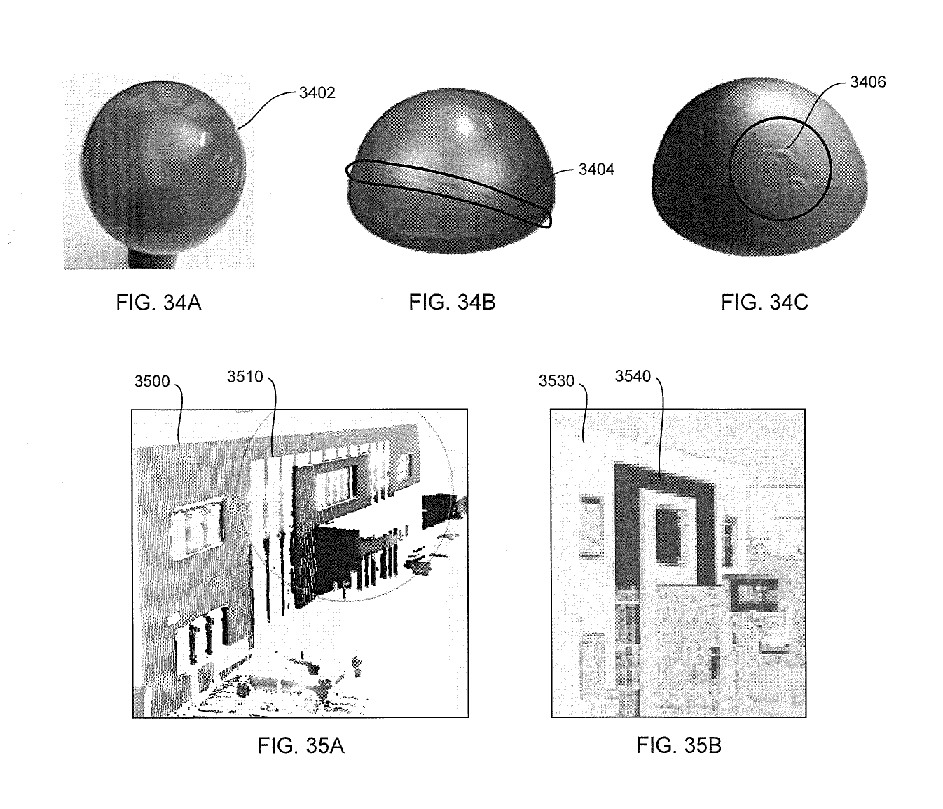

FIG. 34A is a 2D image of a translucent object 3402 having some small features on the spherical surface. In an embodiment, the overall shape of the object 3402 is taken to be a sphere. Normal vectors are determined with respect to a spherical shape. These normal vectors are obtained by determining the DOP and AOP values based on three or more images obtained from linear polarizers at different angles as described herein above with reference to FIGS. 20, 21, and FIG. 22. Based on the calculated normal vectors, detailed features on the surface of the object 3402 may be seen. FIG. 34B shows a stripe defect 3404 on the surface of the object 3402. FIG. 34C shows letters 3406 protruding from the surface of the object 3402. Such small details 3403, 3406 would be difficult to measure with many types of light projecting 3D measuring devices because of the small amount of light returned to the measuring device from the translucent object 3402. However, one or more of the embodiments described herein provide advantages in using polarizing methods to extract details when materials are highly reflecting (for example, polished metal) or nearly transparent (for example, glass).

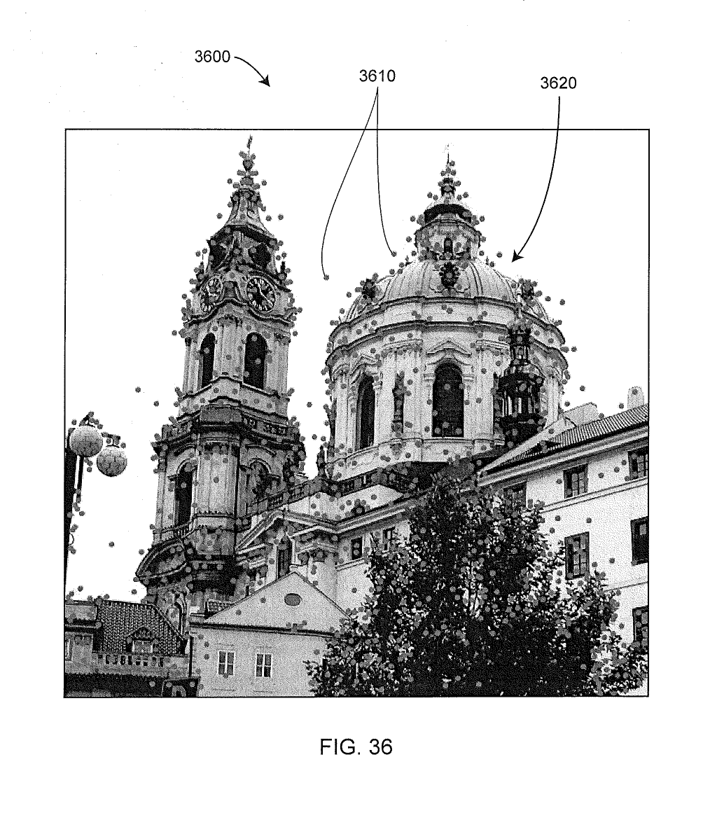

FIG. 35A shows an image of a 3D reconstruction 3500 based on 3D coordinates obtained from a TOF scanner such as the scanner 900 of FIG. 9A or the scanner 2300 of FIG. 23. In this reconstruction, no 3D data is available for the windows 3510 because very little light is reflected back into the TOF scanner from the windows 3510. However, the polarization unit 2310 of the scanner 2300 of FIG. 23 may be used to obtain the normal vectors of the windows. These normal vectors may in turn be used to obtain 3D points that are integrated into 3D representation 3500, as described herein below.

FIG. 35B illustrates the sensitivity of a polarization unit 2310 to reflections from windows 3540 in an object 3530. As discussed herein above, the normal vectors obtained from the polarization unit 2310 are obtained from ambient illumination, which in the embodiment of FIG. 35B comes from sunlight, which may be direct or diffused sunlight.

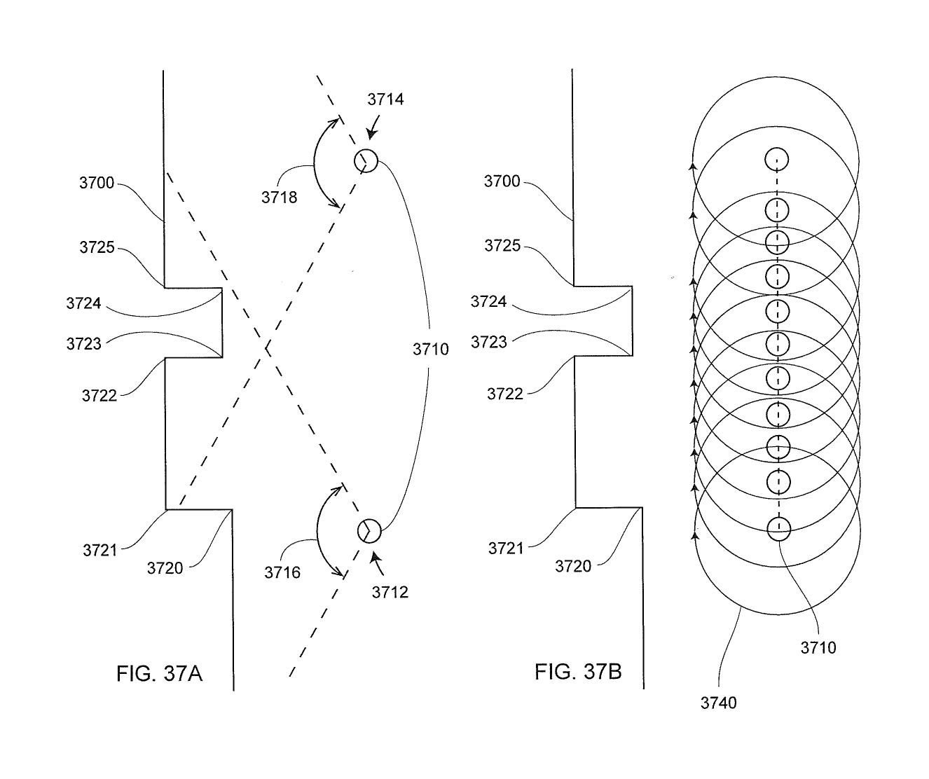

FIG. 36 shows a 2D image 3600 onto which are placed a number of interest points 3610 around a building 3620, also referred to as cardinal points 3610. In the example shown, the method used to obtain the cardinal points 3610 is scale-invariant feature transform (SIFT), described in U.S. Pat. No. 6,711,293 by Sift, the contents of which are incorporated by reference herein. Many other methods are available for determining interest points 3610. Ordinarily, an interest point is defined as a point having a well-founded definition, a well-defined position in space, an image structure that is rich in local information content in a region surrounding the interest point, and a variation in illumination level that is relatively stable over time. A particular example of an interest point is a corner point, which is a point of intersection of three planes. Other common feature detection methods for finding cardinal points 3610 include edge detection, blob detection, and ridge detection. An important aspect of cardinal points 3610 is that they remain fixed in space when they are viewed by a 2D camera from different positions and orientation (that is, from different poses). Because of this property of cardinal points 3610, the cardinal points 3610 may be used to register together multiple collected 3D images, of which FIG. 3000 is one example.

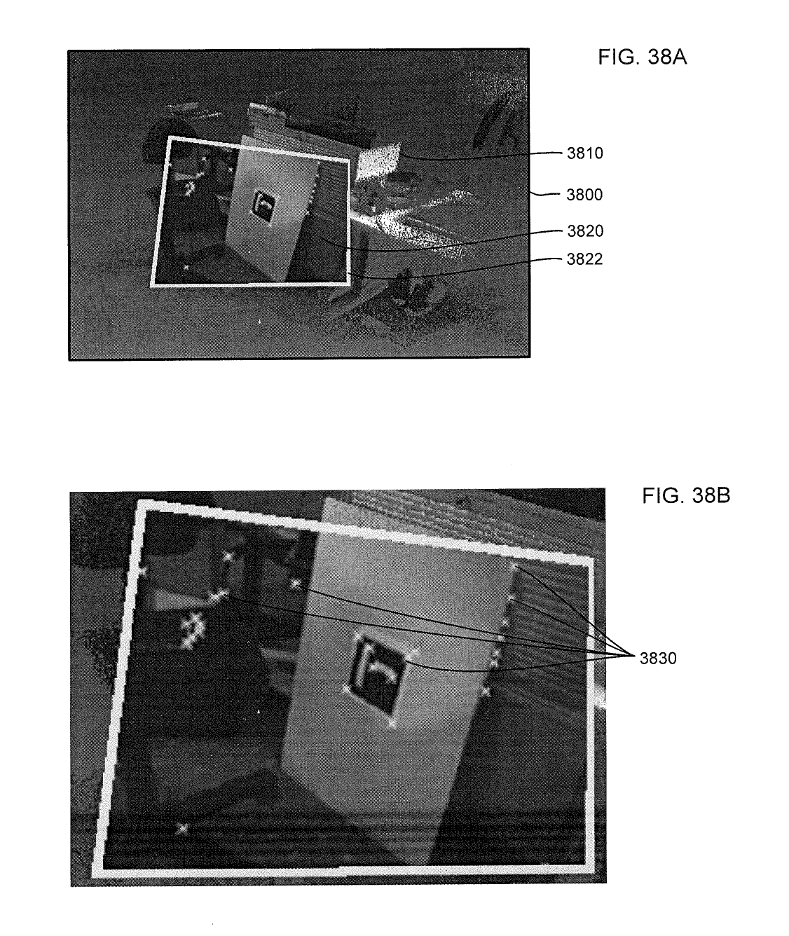

FIGS. 37A, 37B illustrate further examples of cardinal points 3610 and methods for obtaining such cardinal points from multiple camera poses. FIG. 37A is a schematic illustration of a top sectional view of a wall edge 3700 being evaluated by a mobile device 3710 capturing 2D images from each of two locations 3712, 3714 of the mobile device 3710. In some embodiments, multiple 2D images are captured from a plurality of directions for each of the two locations 3712, 3714. For example, the mobile device 3710 may be the TOF scanner 900 as shown in FIGS. 9A, 9B, 9C with a central color camera 930. Such a scanner 900 may steer the camera 930 to point in a number of different directions to record images that cover directions over a large number or the most possible angles about the axes 912, 917 (FIG. 9A). At the positions 3712, 3714, a number of 2D images may be captured in different directions. The cardinal points 3610 of these multiple 2D images from the two positions and the different directions can be registered together to fuse the 2D images into a composite image in three dimensions. The types of natural features that may provide the cardinal points 3610 in the multiple 2D images include wall-wall edge features 3720, 3721, 3722, 3723, 3724, 3725 as well as wall-floor edge features, wall-ceiling edge features, and corner points. The corner points are those points at which two walls meet a floor or a ceiling.

In an embodiment illustrated in 37B, the mobile device 3710 includes multiple cameras so as to capture 2D images more quickly over a wide range of angles. With such a system, the mobile device 3710 may capture 2D photographic images at a multiple positions and at a wide range of angles 3740.

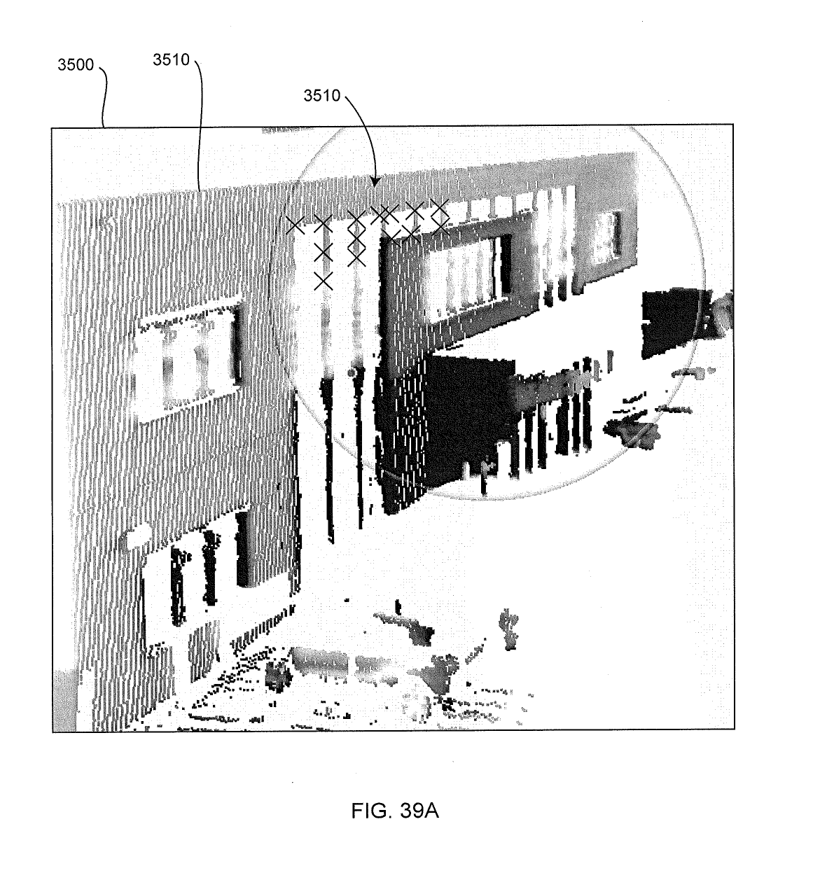

In an embodiment, marks of cardinal points are placed on each 2D images, which can then be matched in successive 2D images. In an embodiment, FIG. 38A is a displayed image 3800 that appears during dynamic scanning of an object 3810 by a scanner 500 shown in FIG. 5, FIG. 6A, and FIG. 6B. In an embodiment, the displayed image 3800 includes a live (e.g. real-time or near real-time) 2D displayed image 3820 captured by a camera 590. In an embodiment, the live 2D displayed image is framed by a box 3822. Previously scanned and registered 3D coordinates are included outside the box 3822. Inside the box, marks 3830 are placed on cardinal points. The cardinal points from each image or frame are registered in sequentially captured 2D images by matching of the cardinal points in the successive images/frames. The result is a collection of 2D images may then be registered in 3D space based on the 3D coordinate data determined by triangulation methods using cameras 510, 530 and projector 550 as described herein.

As explained herein above in reference to FIGS. 35A, 35B, a TOF scanner measures 3D coordinates on materials that scatter sufficient light back to the TOF scanner. Other materials such as glass or polished metal scatter back very little light and hence are not captured in 3D images. However, the polarization unit 2310 may determine surface normal vectors of objects that reflect little light back to the 3D measuring portions of the TOF scanner 2300. In an embodiment, the polarization elements 2320 of the polarization unit 2310 may include any of the polarization elements shown in FIGS. 24A, 24B, 24C, 25A, 25B, 25C, 26A, 26B, 27A, 27B, 27C, 28A, 28B, 28C, 28D, 28E, 29, 30A, 30B, 30C or any other elements capable of capturing images to which at least three linear polarizers are applied at different angles.

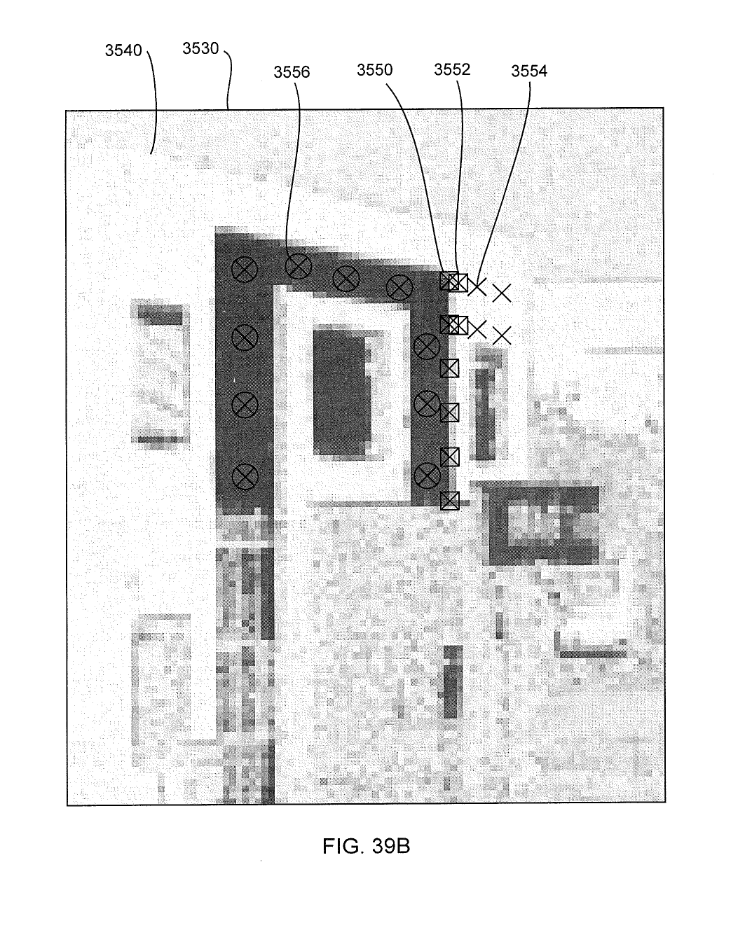

The surface normal data may be combined with 2D cardinal points as described herein above in regard to FIGS. 36, 37A, 37B, 38A, 38B and, in addition, combined with 3D data collected using 3D measuring instruments such as the TOF scanner 2300. FIG. 39A shows a 3D reconstruction 3500 which appears much as it would in a 2D image of the building 3510. Hence the cardinal points 3512 marked with an X as seen in a 2D image of the building 3510 coincide with measured 3D coordinates, for example, as might be measured by a TOF scanner 2300. The glass windows that were left unmeasured in FIG. 39A could be measured using a polarization unit 2310. Referring now to FIG. 39B, this is shown more clearly in marks on the building 3540 in the image 3530. In the image, points 3550, which represent points captured by a 2D camera may coincide with 3D points measured by a scanner. Because the TOF scanner and the polarization unit 2310 are coupled in a common frame of reference, the imaged 2D cardinal points may be aligned to corresponding 3D points measured by the TOF scanner 2300. Some of the points 3550, 3552 represent corner points at which three planes intersect and other of the points 3550, 3552 represent edge points at which two planes intersect. Points 3554 represent points on a common plane. Points 3556 represent locations at which a normal vector is known. The density of such collected points 3550, 3552, 3554, 3556 may be numerous and, in an embodiment, densely cover the 2D image, which in an embodiment is further incorporated into a 3D representation obtained from 3D measured values, for example, from the TOF scanner 2300.

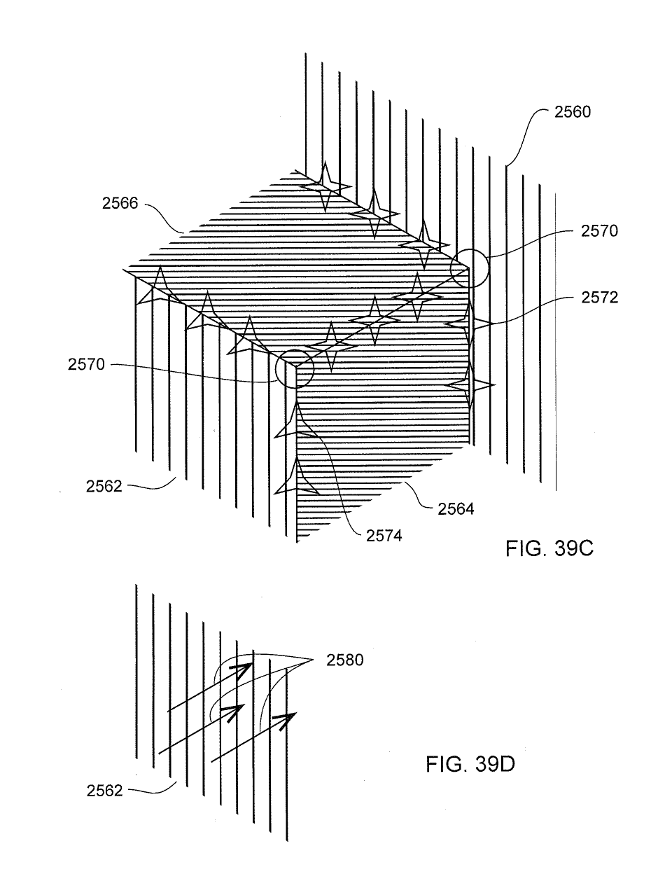

FIGS. 39C, 39D illustrates the type of data that may be collected by a TOF scanner 2300 that includes a polarization unit 2310, as shown in FIG. 23 and FIG. 40. In an embodiment, a portion of an outer wall surface 2560 is separated from a clear glass window 2562 by a window ledge 2566 and vertical window reveal 2564. The points 2570 are corner points at which three planes intersect. The corner points 2570 can be identified both by 2D cardinal points and 3D measured points. However, the 2D cardinal points in contact with the window surface 2562 may be more clearly identified by the polarization unit 2310, which includes a 2D camera, than by the TOF scanner 2300. An advantage of the polarization unit 2310 in this case is its ability to capture a relatively bright image of materials such as windows and polished metals that return little light to a TOF scanner. Further cardinal points accessible to both 2D camera and 3D scanner include edge points 2572, 2574. Besides the 2D and 3D marker points, the polarization unit further provides the information needed to determine normal vectors to the glass surface 2567. By combining this data, a relatively good 3D representation of the entire building 3510 (FIG. 39A) or the building 3540 (FIG. 39B) may be obtained, including 3D representations of the glass windows.

In an embodiment, a three-dimensional (3D) measuring system comprises: a processor system including at least one of a 3D scanner controller, an external computer, and a cloud computer operable for remote network access; a 3D scanner having a first pose, the 3D scanner further having a first light source, a beam-steering unit, a first angle-measuring device, a second angle-measuring device, a first light receiver, and a polarization unit, the first light source operable to emit a first beam of light, the beam-steering unit operable to steer the first beam of light to a first direction onto a first object point, the first direction determined by a first angle of rotation about a first axis and a second angle of rotation about a second axis, the first angle-measuring device operable to measure the first angle of rotation and the second angle measuring device operable to measure the second angle of rotation, the first light receiver operable to receive first reflected light, the first reflected light being a portion of the first beam of light reflected by the first object point, the first light receiver operable to produce a first electrical signal in response to the first reflected light, the first light receiver configured to cooperate with the processor system to determine a first distance to the first object point based at least in part on the first electrical signal, the 3D scanner operable to cooperate with the processor system to determine 3D coordinates of the first object point based at least in part on the first distance, the first angle of rotation and the second angle or rotation, the polarization unit operable to receive incoming light and to apply a first linear polarization at a first polarization angle and measure a first light level in response, the polarization unit further operable to apply a second linear polarization at a second polarization angle and measure a second light level in response, the polarization unit further operable to apply a third linear polarization at a third polarization angle and measure a third light level in response, the processor system further operable to determine a normal vector to a second point on a first surface of the object, the determined normal vector based at least in part on the first polarization angle, the second polarization angle, the third polarization angle, the first light level, the second light level, and the third light level.

In an embodiment, in the 3D measuring system, the second point is illuminated by ambient light.

In an embodiment, in the 3D measuring system, the ambient light is generated by artificial lights in a building.

In an embodiment, in the 3D measuring system, the ambient light is generated by sunlight.

In an embodiment, in the 3D measuring system: the polarization unit includes: a first camera having a first linear polarizer at the first polarization angle, a first lens, and a first photosensitive array operable to measure the first light level of the second point; a second camera having a second linear polarizer at the second polarization angle, a second lens, and a second photosensitive array operable to measure the second light level of the second point; and a third camera having a third linear polarizer at the third polarization angle, a third lens, and a third photosensitive array operable to measure the third light level at the second point.

In an embodiment, in the 3D measuring system, the polarization unit further includes: a fourth camera including a fourth linear polarizer at a fourth polarization angle, a fourth lens, and a fourth photosensitive array operable to measure a fourth light level of the second point, wherein the first polarization angle is zero degrees, the second polarization angle is 45 degrees, the third polarization angle is 90 degrees, and the fourth polarization angle is 135 degrees.

In an embodiment, in the 3D measuring system, the polarization unit further includes: a camera assembly, the camera assembly having a linear polarizer assembly, a lens, and a photosensitive array, the linear polarizer assembly having a linear polarizer and a rotation mechanism operable to rotate the linear polarizer to each of the first polarization angle, the second polarization angle, and the third polarization angle, the photosensitive array operable to measure the first light level at the second point, the second light level at the second point, and the third light level at the second point.

In an embodiment, in the 3D measuring system, the polarization unit further includes: a camera assembly, the camera assembly having a linear polarizer assembly, a lens, and a photosensitive array, the linear polarizer assembly having and a first linear polarizer at a first angle, a second linear polarizer at a second angle, and a third linear polarizer at a third angle, the linear polarizer assembly further including a mechanism configured to selectively move any one of the first linear polarizer, the second linear polarizer, and the third linear polarizer in front of the lens, the photosensitive array operable to measure the first light level of the second point through the first linear polarizer, the second light level of the second point through the second linear polarizer, and the third light level of the second point through the third linear polarizer.

In an embodiment, in the 3D measuring system, the polarization unit further includes: a liquid crystal polarizer operable to selectively produce each one of the first linear polarization at the first polarization angle, the second linear polarization at the second polarization angle, and the third linear polarization at the third polarization angle.

In an embodiment, in the 3D measuring system, the polarization unit further includes: a camera assembly, the camera assembly having a lens, a beam splitter, a first linear polarizer, a second polarizer, a third polarizer, a first photosensitive array, a second photosensitive array, and a third photosensitive array, the first linear polarizer operable to linearly polarize light at the first polarization angle, the second linear polarizer operable to linearly polarize incoming light at the second polarization angle, the third linear polarizer operable to linearly polarize incoming light at the third angle, the first photosensitive array operable to measure the first light level of the second point through the first linear polarizer, the second photosensitive array operable to measure the second light level of the second point through the second linear polarizer, the third photosensitive array operable to measure the third light level of the second point through the third linear polarizer.

In an embodiment, in the 3D measuring system, the polarization unit further includes: a camera assembly, the camera assembly having a lens, a multi-polarization filter, and a photosensitive array, the photosensitive array including an array of pixels, the multi-polarization filter including a collection of linear polarizers, each element of the collection of linear polarizers being aligned to a pixel of the array of pixels, some elements of the collection of linear polarizers operable to linearly polarize light in a first polarization direction, a second polarization direction, and a third polarization direction.

In an embodiment, in the 3D measuring system, the polarization unit includes: an optical filter operable to pass certain wavelengths of light and reject other wavelengths of light.

In an embodiment, in the 3D measuring system, the processor further determines the normal vector to the second point on the first surface based on a determined degree-of-polarization of light reflected from the second point and on a determined angle-of-polarization of the light reflected from the second point.

In an embodiment, in the 3D measuring system, the 3D scanner further comprises: a reference camera coupled to the 3D scanner, the reference camera operable to capture a first 2D reference image in the first pose of the 3D scanner and to capture a second 2D reference image in a second pose of the 3D scanner, the processor operable to determine three corresponding cardinal points in the first 2D reference image and the second 2D reference image, the processor further operable to determine 3D coordinates of the second point based at least in part on the normal vector to the second point on the first surface of the object, the three cardinal points in the first reference image, and the corresponding cardinal points in the second reference image.

In an embodiment, in the 3D measuring system, the reference camera is selected from the group consisting of: a camera contained within the polarization unit and a camera outside the polarization unit.

In an embodiment, in the 3D measuring system, the 3D scanner is further operable to determine a collection of normal vectors for a collection of points on the first surface, the processor further operable to determine a refined 3D shape for the collection of points on the first surface based at least in part on the collection of normal vectors and on an initial 3D shape of the first surface.

In an embodiment, in the 3D measuring system, the initial 3D shape is selected from the group consisting of: a geometrical shape and a CAD model.

In an embodiment, in the 3D measuring system, the geometrical shape is selected from the group consisting of: a plane and a sphere.

In an embodiment, in the 3D measuring system, the initial 3D shape is based at least in part on measurements by a 3D measuring instrument.

In an embodiment, a handheld three-dimensional (3D) triangulation scanner comprises: a projector operable to project a first pattern of light onto a first object at a first instant and to project a second pattern of light at a second instant; a first triangulation camera operable to capture an image of the first pattern of light on the first object in the first instant and to capture an image of the second pattern of light at the second instant; a first registration camera operable to capture, at the first instant, a first registration image of first surfaces illuminated by ambient light, the first registration camera further operable to capture, at the second instant, a second registration image of the second surfaces illuminated by the ambient light; and a polarization unit operable to measure, in a first instant, a first level of ambient through a first linear polarizer at a first angle, a second level of ambient light through a second linear polarizer at a second angle, and a third level of ambient light through a third linear polarizer at a third angle, the polarization unit being further operable to measure, in a second instant, a fourth level of ambient light through the first linear polarizer at the first angle, a fifth level of ambient light through the second linear polarizer at the second angle, and a sixth level of ambient light through the third linear polarizer at the third angle, the processor operable to identify at least three cardinal points of natural features found in the first registration image and the second registration image, the processor further operable to determine first 3D coordinates at the first instant based at least in part on the projected first pattern of light and the captured first pattern of light, the processor further operable to determine second 3D coordinates at the first instant based at least in part on the projected second pattern of light and the captured second pattern of light, the processor further operable to fuse the first 3D coordinates and the second 3D coordinates to obtain 3D coordinates fused in a common frame of reference based at least in part on the first 3D coordinates, the second 3D coordinates, and the at least three cardinal points in the first registration image and the second registration image, the processor further operable to determine first normal vectors of the first object based at least in part on the first angle, the second angle, the third angle, the fourth angle, the fifth angle, the sixth angle, the first level, the second level, the third level, the fourth level, the fifth level, and the sixth level, the processor further operable to combine the first normal vectors with the 3D coordinates fused in the common frame of reference to obtain improved 3D coordinates fused in the common frame of reference.

In an embodiment, in the handheld 3D triangulation scanner, the polarization unit further comprises a first polarization camera, a second polarization camera, and a third polarization camera, the first polarization camera having a first lens and a first photosensitive array, the second polarization camera having a second lens and a second photosensitive array, the third polarization camera having a third lens and a third photosensitive array, the first linear polarizer being placed in front of the first polarization camera, the second linear polarizer being placed in front of the second polarization camera, the third linear polarizer being placed in front of the third polarization camera.

In an embodiment, in the handheld 3D triangulation scanner, the polarization camera further comprises a first lens and a first photosensitive array, sections of the first linear polarizer, the second linear polarizer, and the third linear polarizer being arranged into a single composite multi-angle linear polarizer that is placed in front of the polarization camera.

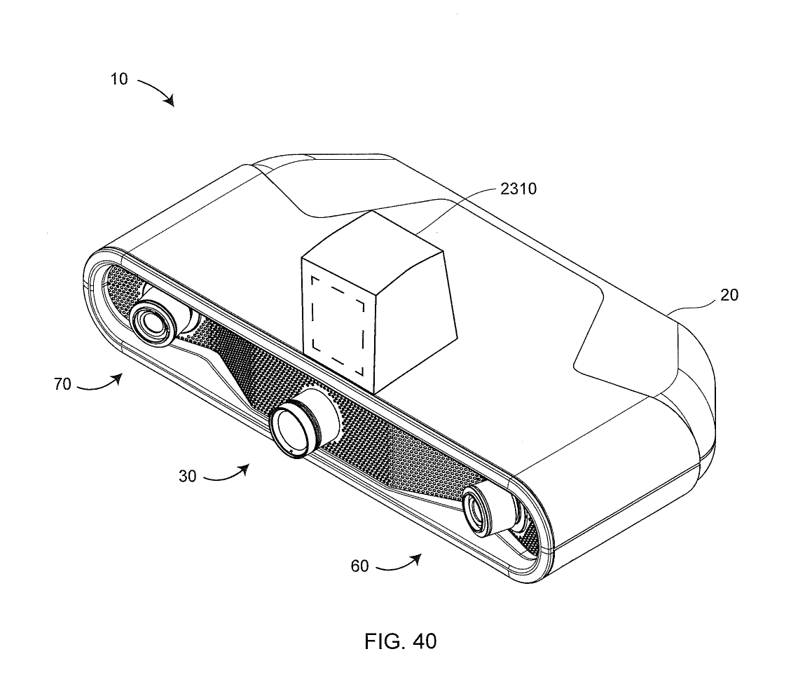

In another embodiment, a polarization unit 2310 is coupled to a triangulation scanner 10, as shown in FIG. 40. The triangulation scanner 10 emits randomly polarized light over a relatively wide angular range and is consequently suitable for use with a polarization unit 2310 (FIG. 40) that uses three of more linear polarizers. In one embodiment, the polarization unit 2310 may be advantageously used with the triangulation scanner 10 to distinguish primary and secondary reflections. Referring to FIG. 41A, an intensity image 4100 is shown of light sent onto a right side (from the view point of the camera) of an object to produce a primary reflection 4102, which further reflects to the left side to produce a secondary reflection 4104. Referring to FIG. 41B a DOP image 4110 is shown that was obtained using the three or more images from the polarization unit 2310. Primary reflections 4102 are not seen in the DOP image 4110 of FIG. 41B, but secondary reflections 4104 are seen. Hence in an embodiment, a polarization unit provides three or more linear polarization images from which a DOP is calculated for each pixel in a photosensitive array to obtain the DOP image 4110, as in FIG. 41B. The obtained DOP image 4110 shows the presence of an undesired multipath interference from the secondary reflections 4104.

FIG. 41C shows an intensity image 4120 of light sent onto a left side of an object to produce primary reflection 4122, which further reflects to the right side of the object to produce a secondary reflection 4124. FIG. 41D shows a DOP image 4130 obtained using three or more images from the polarization unit 2310. Primary reflections 4122 are not seen in the DOP image 4130, but secondary reflections 4124 are seen. Hence in an embodiment, a polarization unit 2310 provides three or more linear polarization images from which a DOP is determined for each pixel in a photosensitive array to obtain the DOP image 4130, as shown in FIG. 41D. The obtained DOP image 4130 shows the presence of an undesired multipath interference from the secondary reflections 4134.

In an embodiment, one method to identify and reduce or eliminate multiple reflections from contaminating captured images in a triangulation scanner is now described in reference to FIGS. 42A, 42B, and FIG. 42C. In an embodiment, a 3D measuring device 4700 includes a triangulation scanner 4710 having a projector 4712 and at least one camera, such as a camera 4711, 4713 (FIG. 42D). The 3D measuring device 4700 further includes a polarization unit 4720 coupled to the triangulation scanner 4710. In an embodiment, the polarization unit 4720 may be one of two types. According to an embodiment, in the first type, the polarization unit 4720 includes a circular polarizer having the same handedness as a circular polarizer on the projector 4712. According to a further embodiment, in the second type, the polarization unit includes three or more linear polarizers, each having a different direction. If the polarization unit 4720 is of the second type, a calculation is performed to determine a DOP image.

In an embodiment, in a first instance illustrated in FIG. 42A, the projector 4712 of the triangulation scanner 4710 sends light 4717A to illuminate an area 4714A that covers all of an object 4730 over the region 4732A. The camera of the polarization unit 4720 captures the image 4740A. The resulting observed region in the image obtained from the polarization unit 4720 indicates those regions 4742A of the region 4732A that receive secondary reflection from the object 4730.

In an embodiment, in a second instance illustrated in FIG. 42B, the projector 4712 sends light 4717B to illuminate a region 4732B of an area 4714B, the region 4732B that matches or overlaps the region 4742A observed by the polarization unit 4720 in the first instance. In response, the camera of the polarization unit 4720 captures an image 4740B that includes a secondary reflection 4742B observed by the polarization unit 4720.

In an embodiment, in a third instance illustrated in FIG. 42C, the projector 4712 sends light 4717C to illuminate a region 4732C of an area 4714C, the region 4732C matches or overlaps the region 4742B observed by the polarization unit 4720 in the second instance. In response, the camera of the polarization unit 4720 captures an image 4740C. In the example of FIG. 42C, the secondary reflections have been eliminated in the acquired image of FIG. 4740C. The result of the steps carried out in the first instance of FIG. 42A, the second instance of FIG. 42B, and the third instance of FIG. 42C is to identify regions that produce multipath interference.

Referring now to FIGS. 42D, 42E, and FIG. 42F, a process is shown that can be performed to determine 3D coordinates with a 3D triangulation scanner. The process involves sequentially illuminating regions selected to reduce or eliminate multipath interference when determining 3D coordinates, with the selected regions based at least in part on the results of the results obtained from the steps carried out in FIGS. 42A, 42B, 42C. In a first 3D measurement step, a region 4732D in an area 4714D that covers all of an object 4730 over the region 4732D. The region 4732D is illuminated by a structured light pattern 4717D emitted by projector 4720, either as a single shot or as a plurality of sequentially projected patterns (for example, as sinusoidal phase-shifted patterns) and cameras 4711, 4713 obtain an image 4740D. In an embodiment, the region 4732D is the same size and shape as region 4732A (FIG. 42A) minus the region 4715D, which is the same size and shape as region 4732B (FIG. 42B).

In a second 3D measurement step at a second instance shown in FIG. 42E, a region 4732E is illuminated by a structured light pattern 4717E is emitted into a portion of the area 4714E by projector 4712 and an image 4720E is acquired by cameras 4711, 4713. In an embodiment, the region 4732E is the same size and shape as region 4732B (FIG. 42B) minus the region 4715E. In an embodiment, the region 4715E is the same size and shape as region 4732C (FIG. 42C).

In a third 3D measurement step at a third instance shown in FIG. 42F, a region 4732F of area 4714F is illuminated by a structured light pattern 4717F emitted by projector 4712 and an image 4740F is acquired by cameras 4711, 4713. In an embodiment, the region 4732F is the region is the same size and shape as region 4715E (FIG. 42E). In the examples described herein in reference to FIGS. 42A, 42B, 42C and FIGS. 42D, 42E, 42F, the number of separate regions to be illuminated (for example, the regions 4732D, 4732E, 4732F) depends on the particular shape and characteristics of the object being measured.

It should be recognized that in many instances circular polarizers used with cameras 4711, 4713 may include circular polarizers having opposite handedness than a circular polarizer on the projector 4712. In many embodiments, this will eliminate or reduce to a desired level the multipath interference in the measured 3D coordinate, such as when the object is made of a metal with a matte finish as shown in FIG. 19B. However, this approach may be less effective if there is significant depolarization of the light as shown in FIG. 19C, for example, as may be seen in some dielectric materials. In such a case, the embodiments of FIGS. 42, 42E, and FIG. 42F may be used to project light in a plurality of regions to advantageously reduce or eliminate multipath interference.

In another embodiment, a method shown in FIG. 42G includes a step of illuminating an object 4730, for example, with a uniform illumination 4717G that covers and area 4714G that covers the entire object 4730 over the region 4732G. In the starting condition of FIG. 42G, the object 4730 has a first orientation 4750H (FIG. 42H), which results in a ray 4752H causing a secondary reflection of the ray 4754H onto another part of the object 4730. This secondary reflection is seen in the region 4742G of an image 4740G acquired by a camera in the polarization unit 4720. In another embodiment, the relative orientation 4751J of the of a portion 4750J of the object 4730 is changed so as to cause the secondary reflection 4754J of a ray of light 4752J to miss the object 4750J, thereby eliminating any observed secondary reflection in the image as shown in image 4740K observed by a camera in the polarization unit 4720. The images 4740K can be rapidly observed as the object 4750J is rotated to different angles 4751J, enabling a user to quickly determine a desired position of the object 4730.

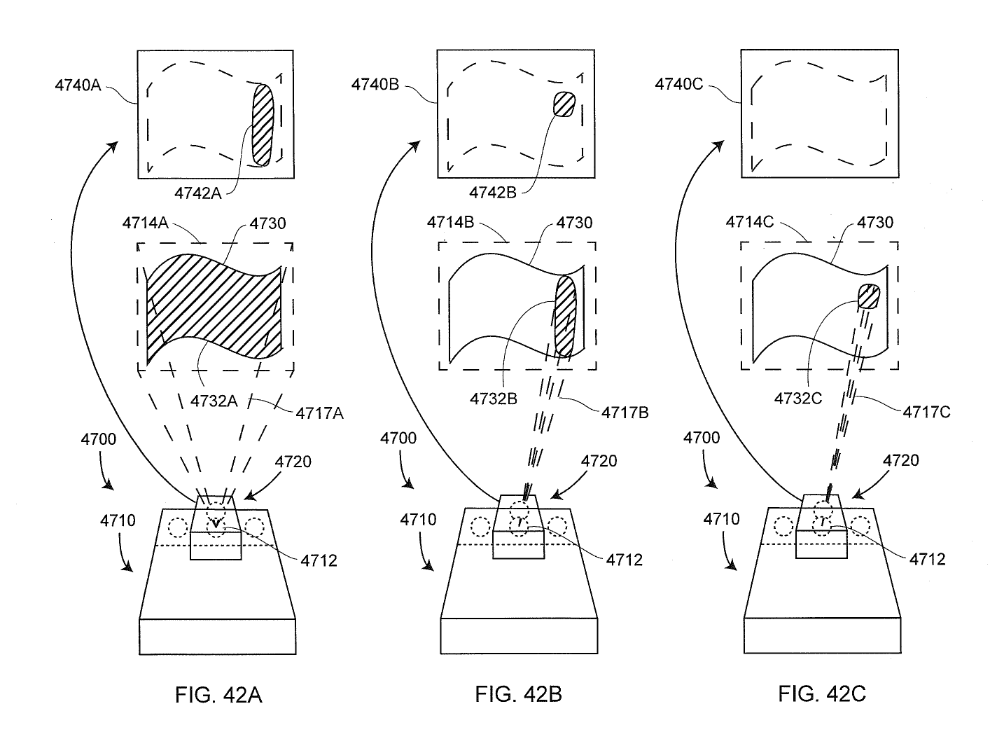

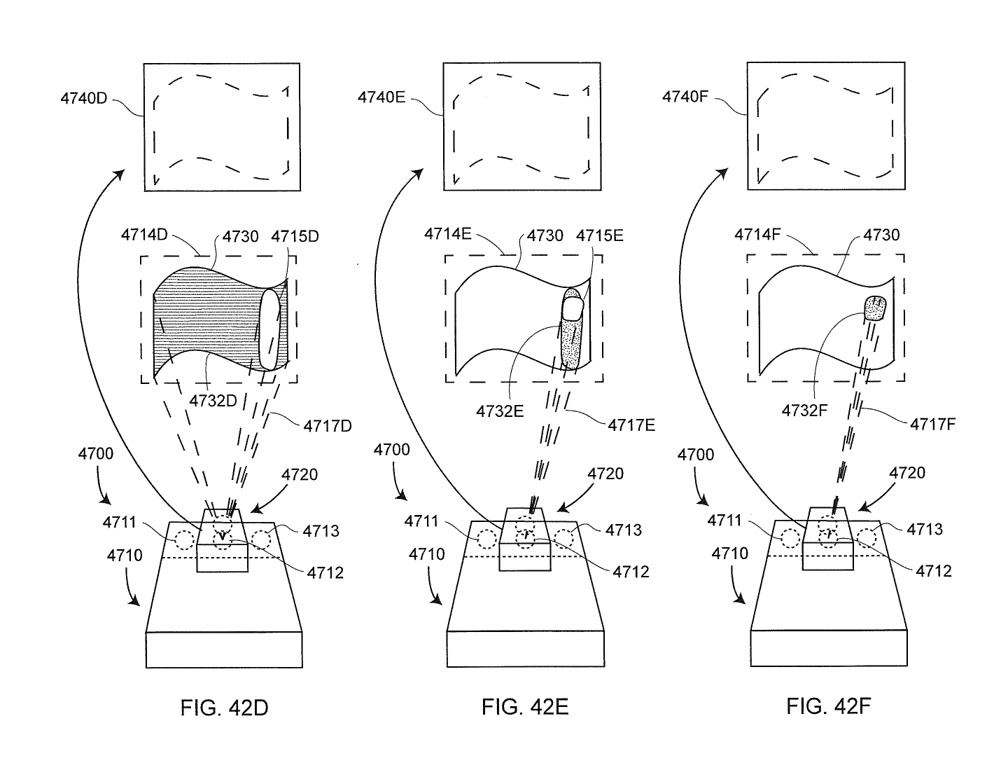

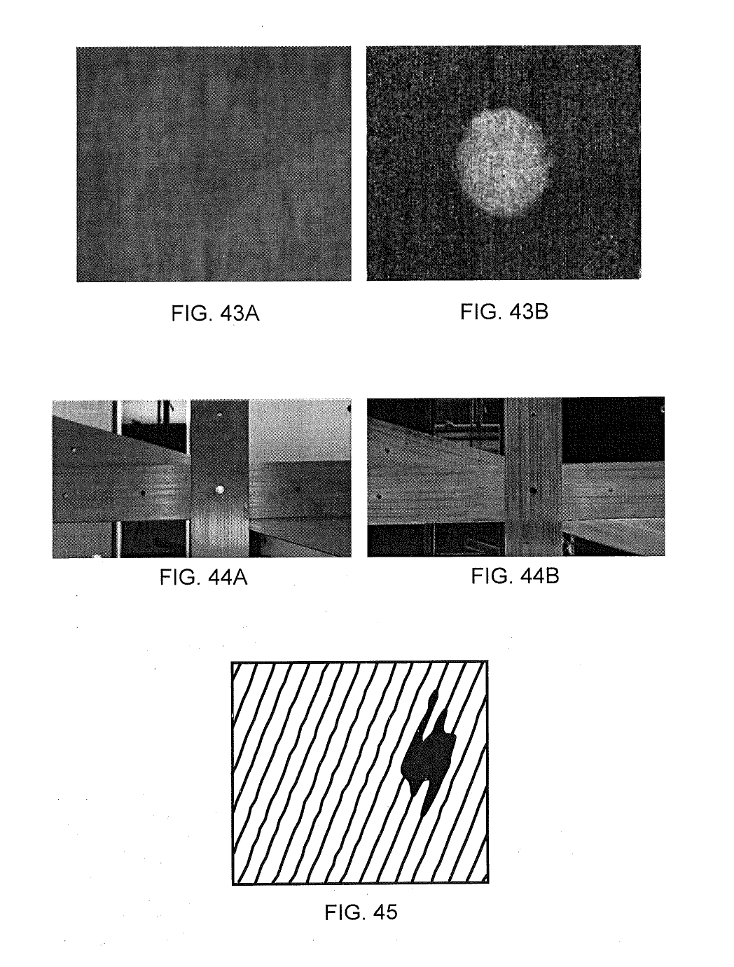

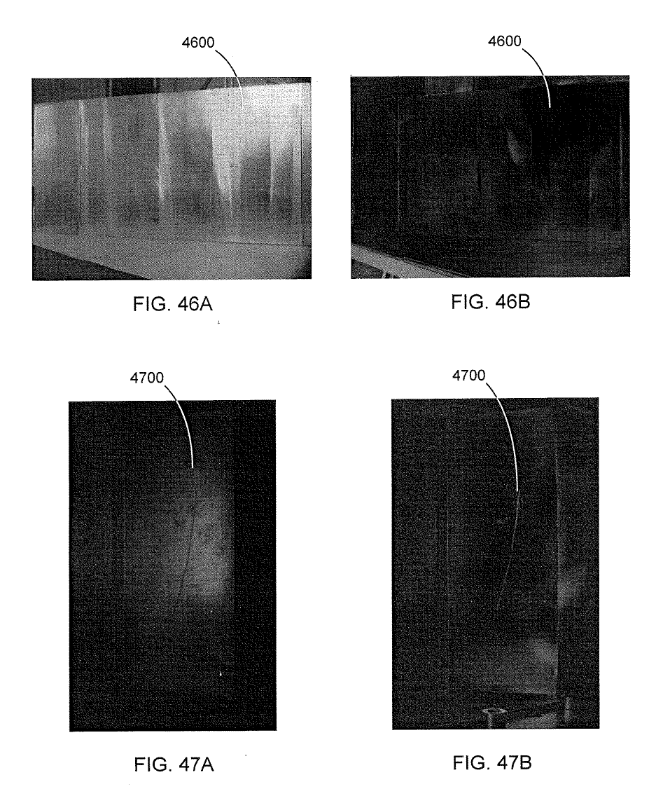

In an embodiment, a polarization unit 2310 is attached to a triangulation scanner as in any of FIGS. 23, 31A, 31B, 32, 33, 40 to obtain three or more images, each obtained with a linear polarizer at a different angle. From the three or more images, a DOP image is obtained, as illustrated in FIGS. 43B, 44B, 46B, 47B. In general, a DOP image may reveal aspects of an object not easily seen in an intensity image. For example, a spot resulting from a small amount of oil is not visible in the intensity image 43A, but is recognizable in the DOP image 43B. In another example, surface texture of machined metal elements is not easily seen in the intensity image of FIG. 44A, but is more clearly visible in the DOP image of FIG. 44B. In another example, a dent is not visible in the intensity image of FIG. 46A but is clearly seen as element 4600 in the DOP image of FIG. 46B. In a further example, a scratch 4700 is not clearly visible in FIG. 47A but can be easily seen in the DOP image of FIG. 47B.

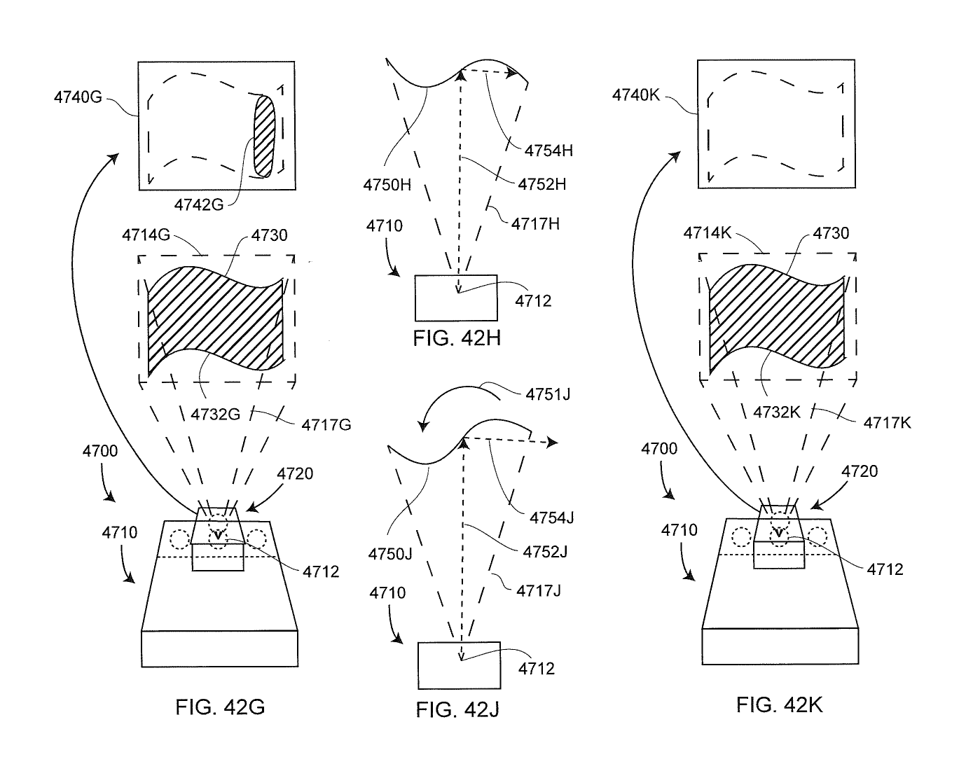

In an embodiment illustrated in FIG. 45, an object has a pattern or texture that is more clearly seen when illuminated by a particular linear polarization. In the case of FIG. 45, the texture of the fabric of FIG. 45 is more clearly viewed when illuminated by a direction of polarization aligned to the texture.

In an embodiment, a three-dimensional (3D) measurement system comprises: a processor system including at least one of a 3D scanner controller, an external computer, and a cloud computer operable for remote network access; a 3D measuring device including a projector operable to project a first light onto an object, the 3D measuring device receiving in response a first reflected light from the object, the 3D measuring device being operable to determine 3D coordinates of the object based at least in part on the projected first light and on the received first reflected light; and a polarization unit operable to measure a first light level of the first reflected light passed through a first linear polarizer at a first polarization angle, to measure a second light level of the first reflected light passed through a second linear polarizer at a second polarization angle, and to measure a third light level of the first reflected light passed through a third linear polarizer at a third polarization angle, the processor system being operable to indicate a presence of first multipath reflection, the presence of the first multipath reflection determined based at least in part on the first polarization angle, the second polarization angle, the third polarization angle, the measured first light level, the measured second light level, and the measured third light level.

In an embodiment, the 3D measurement system is further operable to display an image showing the presence of the first multipath reflection.

In an embodiment, the 3D measurement system is further operable to calculate a degree-of-polarization (DOP), the presence of first multipath reflection being based at least in part on the determined DOP.

In an embodiment, the projector of the 3D measurement system is operable to project a second light onto the object at a first point for which the processor system did not indicate the presence of the first multipath reflection, to receive a second reflected light in response, and to determine 3D coordinates of the first point based at least in part on the projected second light and on the received second reflected light.

In an embodiment, in the 3D measurement system: the 3D measuring device further includes a device camera; the projector is further operable to project a second patterned light onto a portion of the object for which the presence of the first multipath reflection was not indicated by the processor system; the device camera is operable to capture a second device image of the second patterned light on the object; and the processor system is further operable to determine 3D coordinates of a first point on the object based at least in part on the projected second patterned light and on the captured second device image.

In an embodiment, in the 3D measurement system: the projector of the 3D measuring device is further operable to project a second light onto a portion of the object for which the presence of the first multipath reflection was not indicated by the processor system; the 3D measuring device is further operable to receive a second reflected light in responses to the projected second light; and the polarization unit is further operable to measure a fourth light level of the second reflected light passed through the first linear polarizer at the first polarization angle, to measure a fifth light level of the second reflected light passed through the second linear polarizer at the second polarization angle, and to measure a sixth light level of the second reflected light passed through the third linear polarizer at the third polarization angle, the processor system being further operable to indicate a presence of second multipath reflection based at least in part on the first polarization angle, the second polarization angle, the third polarization angle, the fourth light level, the fifth light level, and the sixth light level.

In an embodiment, in the 3D measurement system: the projector is further operable to project a third light onto a second point on the object for which the processor system had neither indicated the presence of the first multipath reflection nor indicated the presence of the second multipath reflection; the 3D measuring device is further operable to receive a third reflected light in response to the projected third light; the processor system further operable to determine 3D coordinates of the second point based at least in part on the projected third light and on the received third reflected light.

In an embodiment, in the 3D measurement system: the 3D measuring device further includes a device camera; the projector is further operable to project a third patterned light onto a portion of the object for which the processor system had neither indicated the presence of the first multipath reflection nor the presence of the second multipath reflection; the device camera is operable to capture a third device image of the third patterned light on the object; and the processor system is further operable to determine 3D coordinates of a second point on the object based at least in part on the projected third patterned light and on the captured third device image.

In an embodiment, a method for measuring three-dimensional (3D) coordinates comprises: providing a processor system, a 3D measuring device, and a polarization unit, the processor system including at least one of a 3D scanner controller, an external computer, and a cloud computer operable for remote network access, the 3D measuring device including a projector; projecting by the projector a first light onto an object and receiving by the 3D measuring device a first reflected light from the object; applying by the polarization unit to the first reflected light a first linear polarization at a first angle to obtain a first polarized light; measuring by the polarization unit a first light level of the first polarized light; applying by the polarization unit to the first reflected light a second linear polarization at a second angle to obtain a second polarized light; measuring by the polarization unit a second light level of the second polarized light; applying by the polarization unit to the first reflected light a third linear polarization at a third angle to obtain a third polarized light; measuring by the polarization unit a third light level of the third polarized light; indicating by the processor system a presence of first multipath reflection, the presence of the first multipath reflection determined based at least in part on the first angle, the second angle, the third angle, the measured first light level, the measured second light level, and the measured third light level; and storing the first angle, the second angle, the third angle, the measured first light level, the measured second light level, and the measured third light level.

In an embodiment, the method for measuring 3D coordinates further comprises: displaying by the processor system an image showing the presence of the first multipath reflection.

In an embodiment, the method for measuring 3D coordinates further comprises: determining by the processor system a degree-of-polarization (DOP) based at least in part on first angle, the second angle, the third angle, the measured first light level, the measured second light level, and the measured third light level.

In an embodiment, the method for measuring 3D coordinates further comprises: displaying by the processor system an image of the DOP, the image of the DOP showing the presence of the first multipath reflection.

In an embodiment, the method for measuring 3D coordinates further comprises: projecting by the projector a second light onto the object at a first point for which the processor system did not indicate the presence of the first multipath reflection; receiving by the 3D measuring device a second reflected light in response to the projected second light; and determining by processor system 3D coordinates of the first point based at least in part on the projected second light and the received second reflected light.

In an embodiment, the method for measuring 3D coordinates further comprises: providing a device camera in the 3D measuring device; projecting with the projector a second patterned light onto a portion of the object for which the presence of the first multipath reflection was not indicated by the processor system; capturing with the device camera a second device image of the second patterned light on the object; and determining by the processor system 3D coordinates of a first point on the object based at least in part on the projected second patterned light and on the captured second device image.

In an embodiment, the method for measuring 3D coordinates further comprises: projecting by the projector a second light onto a portion of the object for which the presence of the first multipath reflection was not indicated by the processor system; receiving by the 3D measuring device a second reflected light in response to the projected second light; measuring with the polarization unit a fourth light level of the second reflected light passing through the first linear polarizer at the first polarization angle; measuring with the polarization unit a fifth light level of the second reflected light passing through the second linear polarizer at the second polarization angle; measuring with the polarization unit a sixth light level of the second reflected light passing through the third linear polarizer at the third polarization angle; and indicating by the processor system a presence of second multipath reflection based at least in part on the first polarization angle, the second polarization angle, the third polarization angle, the fourth light level, the fifth light level, and the sixth light level.

In an embodiment, the method for measuring 3D coordinates further comprises: projecting with the projector a third light onto a second point on the object for which the processor system had neither indicated the presence of the first multipath reflection not the presence of the second multipath reflection; receiving with the 3D measuring device a third reflected light in response to the projected third light; and determining by the processor system 3D coordinates of the second point based at least in part on the projected third light and on the received third reflected light.

In an embodiment, the method for measuring 3D coordinates further comprises: providing the 3D measuring device with a device camera; projecting with the projector a third patterned light onto a portion of the object for which the processor system had neither indicated the presence of the first multipath reflection nor the presence of the second multipath reflection; capturing with the device camera a third device image of the third patterned light on the object; and determining by the processor system 3D coordinates of a second point on the object based at least in part on the projected third patterned light on the captured third device image.

In an embodiment, a three-dimensional (3D) measuring system comprises: a processor including at least one of a 3D scanner controller, an external computer, and a cloud computer operable for remote network access; a 3D measuring device that projects a beam of light onto an object and processes the reflected light to determine 3D coordinates of the object; a polarization unit operable to apply to incoming ambient light a first linear polarization at a first polarization angle and measure a first light level in response, the polarization unit further operable to apply to the incoming ambient light a second linear polarization at a second polarization angle and measure a second light level in response, the polarization unit further operable to apply to the incoming ambient light a third linear polarization at a third polarization angle and measure a third light level in response, the processor being operable to determine a degree-of-polarization (DOP) of the ambient light for corresponding 3D coordinates of the object based at least in part on first polarization angle, the second polarization angle, the third polarization angle, the first light level, the second light level, and the third light level, wherein the processor is further operable to superimpose an image of the DOP of the object on a representation of the determined 3D coordinates of the object.

In an embodiment, in the 3D measuring system, the processor uses the determined DOP to identify a characteristic of the object selected from the group consisting of: a dent in the object, a scratch on the object, a chemical presence on an object, a machining pattern on an object, and a texture of an object.

In an embodiment, a three-dimensional (3D) measurement system comprises: a processor including at least one of a 3D scanner controller, an external computer, and a cloud computer operable for remote network access; a 3D measuring device that projects a first beam of light onto an object and processes the first reflected light to determine 3D coordinates of the object; and a polarization unit operable to apply to the first beam of light a first linear polarization at a first polarization angle and measure a level of the first reflected light in response, the polarization unit further operable to apply to the first reflected light a second linear polarization at a second polarization angle and measure a second light level in response, the polarization unit further operable to apply to the first reflected light a third linear polarization at a third polarization angle and measure a third light level in response, the processor being operable to determine a degree-of-polarization (DOP) of the first reflected light for corresponding 3D coordinates of the object based at least in part on first polarization angle, the second polarization angle, the third polarization angle, the first light level, the second light level, and the third light level, the processor further displaying an image of the DOP, the image of the DOP being indicative of multipath reflection.

In an embodiment, in the 3D measurement system, the processor projects a second beam of light onto the object, the second beam of light not including that portion of the object for which the determined DOP was indicative of multipath reflection.

In an embodiment, in the 3D measurement system, the processor projects a third beam of light onto the object, the third beam of light not outside that portion of the object for which the determined DOP was indicative of multipath reflection.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A three-dimensional (3D) measuring system comprising:
a triangulation scanner having a projector and a first triangulation camera, the projector including a first circular polarizer, the first triangulation camera including a second circular polarizer, the second circular polarizer having handedness opposite the first circular polarizer.

2. The 3D measuring system of claim 1 wherein the first circular polarizer is a left-hand circular polarizer and the second circular polarizer is a right-hand circular polarizer.

3. The 3D measuring system of claim 1 wherein:
the projector is operable to project a first pattern of light onto an object; and
the first triangulation camera is operable to capture a first image of the first pattern of light on the object.

4. The 3D measuring system of claim 3 further comprising a processor operable to determine 3D coordinates of points on the object based at least in part on the projected first pattern and on the captured first image.

5. The 3D measuring system of claim 4 further comprising a first reference camera, the first reference camera including a third circular polarizer, the third circular polarizer having the same handedness as the first circular polarizer, the first reference camera operable to capture a first reference image of the first pattern of light on the object.

6. The 3D measuring system of claim 5 wherein the processor is operable to determine a first region of the object and a second region of the object, the first region and the second region based at least in part on the first reference image.

7. The 3D measuring system of claim 6 wherein:
the projector is operable to project onto the object a second pattern covering at least a portion of the first region;
the first camera is operable to capture a second image of the second pattern on the object; and
the processor is operable to determine 3D coordinates of points on the object in the first region based at least in part on the projected second pattern and the captured second image.

8. The 3D measuring system of claim 7 wherein:
the projector is further operable to project onto the object a third pattern covering at least a portion of the second region;
the first camera is operable to capture a third image of the third pattern on the object; and
the processor is operable to determine 3D coordinates of points on the object in the second region based at least in part on the projected third pattern and the captured third image.

9. The 3D measuring system of claim 4 wherein the first pattern of light extends over a two-dimensional area of the object.

10. The 3D measuring system of claim 9 wherein the first pattern of light is a line pattern.

11. The 3D measuring system of claim 4 wherein the position and orientation of the 3D measuring device is determined by a second 3D measuring device.

12. The 3D measuring system of claim 4 wherein the second 3D measuring device sends a beam of light to a retroreflector coupled to the 3D measuring system.

13. The 3D measuring system of claim 12 wherein the second 3D measuring device tracks the retroreflector and measures 3D coordinates of the retroreflector.

14. The 3D measuring system of claim 4 wherein the first circular polarizer and the second circular polarizer are removable.

15. The 3D measuring system of claim 4 further comprising a mechanism permitting the first circular polarizer to be replaced by an unpolarized optical element or an element having a different polarization state than the first circular polarizer.

16. The 3D measuring system of claim 4 further comprising a mechanism permitting the second circular polarizer to be replaced by an unpolarized optical element or an element having a different polarization state than the second circular polarizer.

17. A method for measuring three-dimensional (3D) coordinates of an object, comprising:
providing a triangulation scanner including a projector, a first triangulation camera, and a processor, the projector including a first circular polarizer, the first triangulation camera including a second circular polarizer having a handedness opposite the first circular polarizer;
projecting with the projector a first pattern of light onto an object;
capturing with the first triangulation camera a first image of the first pattern of light on the object;
determining with the processor 3D coordinates of points on the object based at least in part on the projected first pattern and on the captured first image; and
storing the 3D coordinates of the 3D coordinates of the points on the object.

18. The method of claim 17 further comprising:
providing a first reference camera that includes a third circular polarizer having the same handedness as the first circular polarizer; and
capturing with the first reference camera a first reference image of the first pattern of light on the object.

19. The method of claim 18 further comprising determining with the processor a first region of the object and a second region of the object based at least in part on the first reference image.

20. The method of claim 19 further comprising:
projecting with the projector a second pattern onto the object, the second pattern covering at least a portion of the first region;
capturing with the first camera a second image of the second pattern on the object; and
determining with the processor the 3D coordinates of points on the object in the first region based at least in part on the projected second pattern and the captured second image.

21. The method of claim 20 further comprising:
projecting with the projector a third pattern onto the object, the third pattern covering at least a portion of the second region;
capturing with the first camera a third image of the third pattern on the object; and
determining with the processor the 3D coordinates of points on the object in the second region based at least in part on the projected third pattern and the captured third image.
